(19) United States
(12) Patent Application Publication
(10) Pub. No.: US 2025/0232702 A1
(43) Pub. Date: Jul. 17, 2025

(54) IMAGE ENHANCEMENT FRAMEWORK

(71) Applicant: VISTEON GLOBAL TECHNOLOGIES, INC., Van Buren Township, MI (US)

(72) Inventor: Paul Fredrick Luther Weindorf, Novi, MI (US)

(73) Assignee: VISTEON GLOBAL TECHNOLOGIES, INC., Van Buren Township, MI (US)

(21) Appl. No.: 19/015,987

(22) Filed: Jan. 10, 2025

Related U.S. Application Data
(60) Provisional application No. 63/620,255, filed on Jan. 12, 2024.
(60) Provisional application No. 63/620,257, filed on Jan. 12, 2024.
(60) Provisional application No. 63/620,264, filed on Jan. 12, 2024.

(51) Int. Cl. G09G 3/20; B60K 35/22; G06T 5/40; G06T 5/94

(52) U.S. Cl. CPC G09G 3/2007; B60K 35/22; G06T 5/40; G06T 5/94; B60K 2360/21; G09G 2320/0233; G09G 2320/0666; G09G 2320/0673; G09G 2330/023; G09G 2354/00; G09G 2360/16; G09G 2380/10

(57) ABSTRACT

An image enhancement system includes an ambient light sensor, a circuit and a processor. The ambient light sensor is operational to measure an ambient light level. The circuit is operational to: generate a histogram based on an input video signal; export the histogram; receive a gray shade look up table; and generate an output video signal by converting a plurality of gray shades in the input video signal based on the gray shade look up table. The processor is operational to: receive the histogram from the circuit; develop the gray shade look up table based on the histogram and the ambient light level; and transfer the gray shade look up table to the circuit.

### CROSS-REFERENCE TO RELATED APPLICATIONS

This application claims the benefit of U.S. Provisional Application Nos. 63/620,255 filed Jan. 12, 2024, 63/620,257 filed Jan. 12, 2024, and 63/620,264 filed Jan. 12, 2024, which are hereby incorporated by reference in their entirety.

### TECHNICAL FIELD

The present disclosure generally relates to systems and methods for vehicle display image enhancement.

### BACKGROUND

In automotive display applications, light sensors have been utilized to automatically control the display luminance as a function of the ambient lighting environment. As the ambient illumination increases, the display luminance increases to maintain visibility of the images. Automatic luminance control methods maintain a comfortable level of viewing brightness, and reduce a display power consumption as the ambient illumination decreases. Although automatic luminance control methods maintain visibility of the symbols for peak-white gray shades, the visibility of lower gray shades may be compromised.

### SUMMARY

An image enhancement system is provided herein. The image enhancement system includes an ambient light sensor, a circuit and a processor. The ambient light sensor is operational to measure an ambient light level. The circuit is operational to: generate a histogram based on an input video signal; export the histogram; receive a gray shade look up table; and generate an output video signal by converting a plurality of gray shades in the input video signal based on the gray shade look up table. The processor is operational to: receive the histogram from the circuit; develop the gray shade look up table based on the histogram and the ambient light level; and transfer the gray shade look up table to the circuit.

A method for image enhancement is provided herein, The method includes measuring an ambient light level with an ambient light sensor, generating a histogram with a circuit based on an input video signal, exporting the histogram from the circuit to a processor, receive the histogram at the processor from the circuit, developing a gray shade look up table with the processor based on the histogram and the ambient light level, transferring the gray shade look up table from the processor to the circuit, receiving the gray shade look up table at the circuit from the processor, and generating an output video signal with the circuit by converting a plurality of gray shades in the input video signal based on the gray shade look up table.

A vehicle is provided herein. The vehicle includes an ambient light sensor, a control unit, and a display panel. The ambient light sensor is operational to measure an ambient light level. The control unit is coupled to the ambient light sensor and is operational to generate an input video signal, generate a histogram based on the input video signal, develop a gray shade look up table based on the histogram and the ambient light level, and generate an output video signal by converting a plurality of gray shades in the input video signal based on the gray shade look up table. The display panel is coupled to the control unit and is operational to generate a visible image based on the video output signal.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a platform.

FIG. 2 illustrates a graph of a histogram of gray shades in an image.

FIG. 3 illustrates a graph of a gray shade ratio.

FIG. 4 illustrates a graph for a first histogram detection.

FIG. 5 illustrates a graph for a second histogram detection.

FIG. 6 illustrates a graph of a first example offset gamma curve.

FIG. 7 illustrates a graph of a comparison between a constant contrast ratio method and a gamma method.

FIG. 8 illustrates a contrast ratio as a function of background luminance.

FIG. 9 illustrates an example illuminance inside an integrating hemisphere.

FIG. 10 illustrates a graph of an example end point slope gamma matching function.

FIG. 11 illustrates a graph of a display luminance with end point slope gamma matching function.

FIG. 12 illustrates a graph of a pupillary light reflex to a blue light stimulus.

FIG. 13 illustrates an intermediate functional block diagram of a system.

FIG. 14 illustrates a functional block diagram of an image enhancement architecture.

FIG. 15 illustrates a graph for a start point function definition.

FIG. 16 illustrates a graph of a gray shade histogram.

FIG. 17 illustrates a graph on an offset gray shade remapping.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a framework to determine gray scale transfer functions for display image enhancements. The gray scale transfer functions generally have three independent functions. A start point function based ambient lighting conditions is used to improve low gray shade visibility. An intermediate gray shade stretching function is used to ensure image gray shade visibility. An end point function is based on white shade image content. The three functions are stitched together using a slope matching gamma function.

In various embodiments, Adaptive Image Enhancement (AIE) and Low Video Enhancement (LVE) is provided in the framework. The adaptive image enhancement generally compensates for distorted linearity of grey level perception under ambient light conditions. The adaptive image enhancement may enhance and optimize perceived overall brightness of image content for given ambient conditions. Roll-off functions are implemented to minimize loss of image details. A local contrast preservation feature ensures legibility of contrast sensitive image information. A prevention of noise enhancement due to excessive gain is implemented for dark grey levels of the images. Robustness for all type of image content, especially for all kinds of Human Machine Interface (HMI) content is also provided.

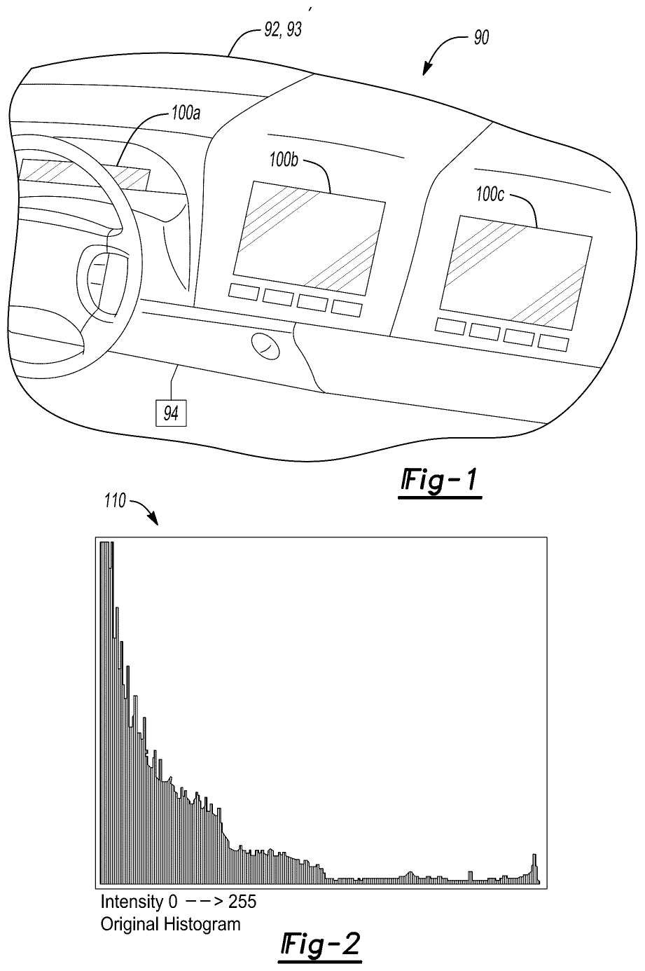

FIG. 1 illustrates a context of a platform 90 in accordance with one or more exemplary embodiments. The platform 90 generally includes an instrument panel 92. The instrument panel 92 includes a control unit 94 and one or more display panels 100a-100c. The instrument panel 92 may be implemented as part of a vehicle 93. The vehicle 93 may include mobile vehicles such as automobiles, trucks, motorcycles, boats, trains and/or aircraft. In some embodiments, the instrument panel 92 may be part of a stationary object. The stationary objects may include, but are not limited to, billboards, kiosks, and/or marquees. Other types of platforms 90 may be implemented to meet the design criteria of a particular application.

The control unit 94 implements one or more display-drive circuits. The control unit 94 is generally operational to generate control signals that drive the display panels 100a-100c. In various embodiments, the control signals may be configured to provide instrumentation (e.g., speed, tachometer, fuel, temperature, etc.) to at least one display panel 100a-100c (e.g., 100a). In some embodiments, the control signals may also be configured to provide video (e.g., a rear-view camera video, a forward-view camera video, an onboard DVD player, etc.) to the display panels 100a-100c. In other embodiments, the control signals may be further configured to provide alphanumeric information shown on one or more of the display panels 100a-100c.

In various embodiments, the control unit 94 generally comprises at least one microcontroller. The at least one microcontroller may include one or more processors, each of which may be embodied as a separate processor, an application specific integrated circuit (ASIC), a field programmable gate array (FPGA), or a dedicated electronic control unit.

The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry. The at least one microcontroller may be embedded as part of an FPGA or ASIC device.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components in the platform 90 and communicate instructions to the display panels 100a-100c through one or more control signals to control the displays panels 100a-100c.

The display panels 100a-100c are generally mounted to the instrument panel 92. In various embodiments, one or more of the display panels 100a-100c may be disposed inside the platform 90 (e.g., vehicle 93). In other embodiments, one or more of the display panels 100a-100c may be disposed exterior to the platform 90. One or more display panels 100a-100c may implement an active public/privacy viewing modes. One or more display panels 100a-100c may also implement the privacy mode. As illustrated, the display panel 100a may be a cluster display positioned for use by a driver. The display panel 100b may be a console display positioned for use by the driver and a passenger. The display panel 100c may be a passenger display positioned for use by the passenger and the driver.

FIG. 2 illustrates a graph of an example histogram 110 of gray shades in an image in accordance with one or more exemplary embodiments. The image histogram 110 illustrated in the figure is primarily used to determine if little higher shade content (e.g., on the right side of the histogram 110) exists in the image in order to allow the lower shades (e.g., on the left side of the histogram 110) to be stretched. Furthermore, low video enhancement basically offsets the image such that the lower gray shade levels may become visible.

In order to determine a correct function to offset the lower gray shades into the realm of visibility, past human factor studies provide insight. Maintaining a constant contrast ratio may not be a preferred approach because a contrast sensitivity of an observer generally increases as ambient illumination increases. In particular, relatively low contrast ratios may be used at high illumination levels. Furthermore, the forward-field-of view (FFOV) luminance may also be taken into consideration to correct for eye adaptation mismatch while the eye is looking at a bright scene through the windshield and the ambient light level on the display is low due to a shadowing condition.

A human perception adaptation may be considered a straight line on a log-log plot of display background luminance verses information display luminance. Most literature focuses on a legibility of primary information. Burnette studies indicate that a minimum legibility plot is also established that may be more germane as the function for lower luminance levels in a display image because the lower levels (such as shading enhancements) are often used to display secondary information. Additional details of the Burnette studies may be found in the paper “The Status of Human Perceptual Characteristics Data for Electronic Flight Display Design”, Proceedings of AGARD Conference No. 96 on Guidance and Control Displays, Paris, France, 1972, by K. T. Burnette, which is hereby incorporated by reference in its entirety. Additional details for human visual system utilization for display visibility may be found in the paper “The Development and Evaluation of Color Systems for Airborne Applications—Phase I: Fundamental Visual Perceptual, and Display Systems Considerations”, July 1985, by Dr. Louis Silverstein and Robin Hoerner, which is hereby incorporated by reference in its entirety.

### Framework:

In various embodiments, the framework is based on a combination of a Silverstein fractional power function and use of constant luminance ratios between sequential gray shades taking into account an ambient reflective light. An ambient light sensor is provided to measure the ambient light level and is proportional to the background luminance seen by the viewer. In order to visibly perceive a first gray shade (GS1), the luminance level of GS1 may be increased to provide a sufficient contrast ratio between GS1 and a reflected background luminance (LBG). It may be noted that the black gray shade, GS0, is not be altered and may be assigned with the output GS0 value. Per the Silverstein visibility criteria, the Emitted Symbol Luminance (ESL) may be determined per Equation 1 as follows:

$$E S L = {{B}_{O} ( {L}_{BG} )}^{C} \qquad Eq . ( 1 )$$

Where:
ESL=Emitted Symbol Luminance in cd/m².
B_{O}=Luminance Offset Constant.
L_{BG}=Display Background Luminance in cd/m².
c=Power Constant (e.g., a slope of the power function in logarithmic coordinates and is generally a fractional number).

By way of example, a minimum contrast ratio between symbols and the background may be 5:1 for night conditions, 3:1 for twilight conditions, 3:1 for day conditions, and 2:1 for direct sunlight conditions. Using Equation 1, the minimum luminance, L_{Min}, that the user sees when looking at GS1 may be devised per Equation 2 as follows:

$${L}_{M i n} = {{B}_{O} ( {L}_{BG} )}^{C} + {L}_{BG} \qquad Eq . ( 2 )$$

A maximum luminance that the user sees when looking at the maximum gray shade may be according to Equation 3 as follows:

$${L}_{M ax} = {L}_{DMax} + {L}_{BG} \qquad Eq . ( 3 )$$

Where L_{DMax} is the display maximum luminance value.

Note that in both Equations 2 and 3, the reflected display background luminance, LBG, is added because that is what the user actually sees.

To determine the gray shade luminance values between L_{Min} and L_{Max} the concept of constant luminance ratios is introduced. The eye basically sees equal luminance ratios as equal increments in luminance and therefore affords an ability to distinguish all gray shades equally. Equation 4 may be utilized to determine the desired intermediate luminance values as follows:

$${L}_{SEL} = \frac{{L}_{M ax}}{{[ \frac{{L}_{M ax}}{{L}_{M i n}} ]}^{( \frac{T - N}{T - 1} )}} \qquad Eq . ( 4 )$$

Where T is the total number of luminance levels and N is the gray shade number.

Substituting Equations 2 and 3 into Equation 4 yields Equation 5 as follows:

$${L}_{SEL} = \frac{{L}_{DMax} + {L}_{BG}}{{[ \frac{{L}_{DMax} + {L}_{BG}}{{{B}_{O} ( {L}_{BG} )}^{C} + {L}_{BG}} ]}^{( \frac{T - N}{T - 1} )}} \qquad Eq . ( 5 )$$

Equation 5 may be utilized to determine every Nth gray shade luminance value for 8 bit per color input (N=1 through 255 and T=255).

The gray shade luminance values determined by Equation 5 are decomposed into the new gray shade values, GS_{N}, based on using a larger number of gray shade levels, such as a 10-bits range. Equation 6 shows the relationship between the display luminance and the new gray shade number, GS_{N}, and the total number of bits, N_{New} as follows:

$${L}_{{GS}_{N}} = {{L}_{DMax} ( \frac{{GS}_{N}}{{2}^{{N}_{New}} - 1} )}^{γ} \qquad Eq . ( 6 )$$

Where the display gamma is notated as γ.

A next step is to recognize that the luminance values, L_{SEL}, determined in Equation 5 includes the reflected background luminance, L_{BG}. Therefore, the background luminance is subtracted to determine the display luminance. Consequently, using Equation 6, Equation 7 may be formulated as follows:

$${L}_{SEL} - {L}_{BG} = {{L}_{DMax} ( \frac{{GS}_{N}}{{2}^{{N}_{New}} - 1} )}^{γ} \qquad Eq . ( 7 )$$

Solving Equation 7 for GS_{N} yields Equation 8 as follows:

$${GS}_{N} = {( {2}^{{N}_{New}} - 1 ) [ \frac{{L}_{SEL} - {L}_{BG}}{{L}_{DMax}} ]}^{( \frac{1}{γ} )} \qquad Eq . ( 8 )$$

Thereafter, Equation 5 may be substituted into equation 8 for L_{SEL} thereby yielding equation 9 as follows:

$${GS}_{N} = {( {2}^{{N}_{New}} - 1 ) [ \frac{\frac{{L}_{DMax} + {L}_{BG}}{{[ \frac{{L}_{DMax} + {L}_{BG}}{{{B}_{O} ( {L}_{BG} )}^{C} + {L}_{BG}} ]}^{( \frac{T - N}{T - 1} )}} - {L}_{BG}}{{L}_{DMax}} ]}^{( \frac{1}{γ} )} \qquad Eq . ( 9 )$$

Therefore, Equation 9 may be used to input gray shade numbers (e.g., numbers 1 through 255) for N, and based on the background luminance determined by a light sensor, the new gray shade values, GS_{N}, may be determined. The gray shade determinations may be equally applied for red, green and blue to maintain a correct white color point. The above concept may also be applied to stretch the dynamic range of a low gray shade image.

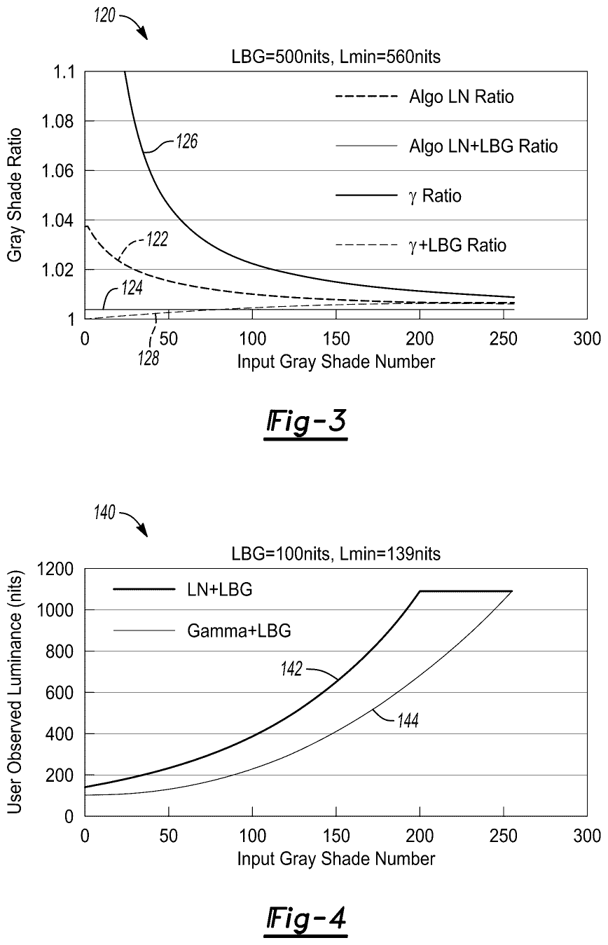

FIG. 3 illustrates a graph 120 of a gray shade ratio for a simulation in accordance with one or more exemplary embodiments. The Algo LN ratio Line 122 is the ratio between successive gray shades of the display luminance with LVE compensation. It does not represent what the user will see. The Algo LN+LBG Ratio Line 124 is the ratio between successive gray shades of the display+background luminance with LVE compensation. It represents what the user will see. The γ Ratio Line 126 is the ratio between successive gray shades of the display luminance without LVE compensation. It represents what the user will see with LVE compensation. The γ+LBG Ratio Line 128 is the ratio between successive gray shades of the display+background luminance without LVE compensation. It represents what the user will see without the LVE compensation.

### AIE Gray Shade Stretching:

A method to accomplish gray shade expansion or stretching is to use the constant ratio formula, as shown in Equation 9 above. For instance, if the frame histogram as shown in FIG. 2 has a detection threshold of N_{Max} gray shades, then Equation 9 may be modified to set T=N_{Max} as shown in Equation 10 as follows:

$${GS}_{N} = {( {2}^{{N}_{New}} - 1 ) [ \frac{\frac{{L}_{DMax} + {L}_{BG}}{{[ \frac{{L}_{DMax} + {L}_{BG}}{{{B}_{O} ( {L}_{BG} )}^{C} + {L}_{BG}} ]}^{( \frac{{N}_{Max} - N}{{N}_{Max} - 1} )}} - {L}_{BG}}{{L}_{DMax}} ]}^{( \frac{1}{{γ}_{D}} )} \qquad Eq . ( 10 )$$

Note that γ has been changed to γ_{D} to better convey that the gamma is the target display γ value. Any gray shades greater than T_{NewMax} is set to T_{NewMax}.

FIG. 4 illustrates a graph 140 for a first histogram detection in accordance with one or more exemplary embodiments. Using the parameters L_{BG}=100 nits and CR_{GS1}=1.12, if a detection threshold is determined to be gray shade 200, the result of setting N_{Max}=200 in Equation 10 are illustrated in FIG. 4 as an LN+LBG line 142 and a γ+LBG line 144.

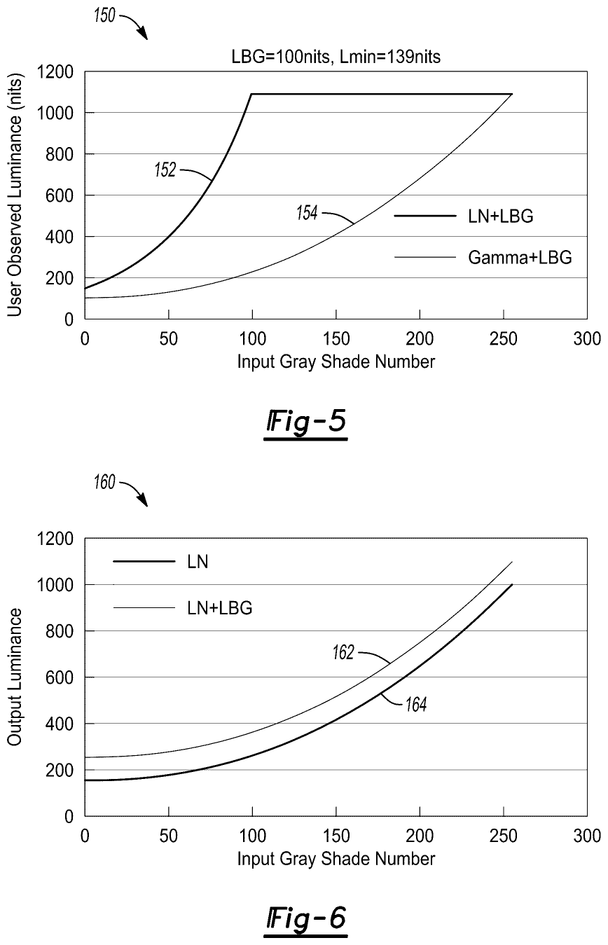

FIG. 5 illustrates a graph 150 for a second histogram detection in accordance with one or more exemplary embodiments. If the image becomes even darker and the histogram detection threshold becomes N_{Max}=100, the resulting LN+LBG line 152 and a γ+LBG line 154 are illustrated in FIG. 5 using the parameters L_{BG}=100 nits and CR_{GS1}=1.12.

The results show that the general formula per Equation 10 may be used for both LVE and AIE. It also demonstrates the simplistic nature of the entire system when the constant luminance ratio approach is utilized in conjunction with the fractional power function offset.

Equation 10 may be further simplified by taking the interior term and assigning variables “A” and “B” values as shown in Equation 11 as follows:

$$\frac{{L}_{DMax} + {L}_{BG}}{{[ \frac{{L}_{DMax} + {L}_{BG}}{{{B}_{O} ( {L}_{BG} )}^{C} + {L}_{BG}} ]}^{( \frac{{N}_{Max} - N}{{N}_{Max} - 1} )}} = \frac{A}{{[ \frac{A}{B} ]}^{( \frac{{N}_{Max} - N}{{N}_{Max} - 1} )}} \qquad Eq . ( 11 )$$

For convenience, exponent laws are shown in Equations 12 through 16 as follows:

$${a}^{- n} = \frac{1}{{a}^{n}} ( a \neq 0 ) \qquad Eq . ( 12 )$$

$${a}^{0} = 1 ( a \neq 0 ) \qquad Eq . ( 13 )$$

$${a}^{m} {a}^{n} = {a}^{m + n} \qquad Eq . ( 14 )$$

$${( {a}^{m} )}^{n} = {a}^{mn} \qquad Eq . ( 15 )$$

$${( ab )}^{n} = {a}^{n} {b}^{n} \qquad Eq . ( 16 )$$

Using Equation (exponent law) 12, Equation 11 may be rewritten as Equation 17 as follows:

$$\frac{A}{{[ \frac{A}{B} ]}^{( \frac{{N}_{Max} - N}{{N}_{Max} - 1} )}} = {A [ \frac{A}{B} ]}^{- 1 ( \frac{{N}_{Max} - N}{{N}_{Max} - 1} )} \qquad Eq . ( 17 )$$

Using Equation (exponent law) 12 again results in Equation 18 as follows:

$$\frac{A}{{[ \frac{A}{B} ]}^{( \frac{{N}_{Max} - N}{{N}_{Max} - 1} )}} = {{{A}^{1} [ A ]}^{( \frac{N - {N}_{Max}}{{N}_{Max} - 1} )} [ B ]}^{- 1 ( \frac{N - {N}_{Max}}{{N}_{Max} - 1} )} \qquad Eq . ( 18 )$$

Using Equations (laws 15 and 16), Equation 18 is transformed into Equation 19 as follows:

$$\frac{A}{{[ \frac{A}{B} ]}^{( \frac{{N}_{Max} - N}{{N}_{Max} - 1} )}} = {{{A}^{1} [ A ]}^{( \frac{N - {N}_{Max}}{{N}_{Max} - 1} )} [ B ]}^{- 1 ( \frac{N - {N}_{Max}}{{N}_{Max} - 1} )} \qquad Eq . ( 19 )$$

Next, using Equation 14, Equation 19 becomes Equation 20 as follows:

$$\frac{A}{{[ \frac{A}{B} ]}^{( \frac{{N}_{Max} - N}{{N}_{Max} - 1} )}} = {{[ A ]}^{( 1 + \frac{N - {N}_{Max}}{{N}_{Max} - 1} )} [ B ]}^{( \frac{{N}_{Max} - N}{{N}_{Max} - 1} )} \qquad Eq . ( 20 )$$

The exponent may be modified for a common denominator per Equation 21 as follows:

$$\frac{A}{{[ \frac{A}{B} ]}^{( \frac{{N}_{Max} - N}{{N}_{Max} - 1} )}} = {{[ A ]}^{( \frac{{N}_{Max} - 1}{{N}_{Max} - 1} + \frac{N - {N}_{Max}}{{N}_{Max} - 1} )} [ B ]}^{( \frac{{N}_{Max} - N}{{N}_{Max} - 1} )} \qquad Eq . ( 21 )$$

Adding the numerators for “A”, the exponential term yields Equation 22 as follows:

$$\frac{A}{{[ \frac{A}{B} ]}^{( \frac{{N}_{Max} - N}{{N}_{Max} - 1} )}} = {{[ A ]}^{( \frac{N - 1}{{N}_{Max} - 1} )} [ B ]}^{( \frac{{N}_{Max} - N}{{N}_{Max} - 1} )} \qquad Eq . ( 22 )$$

Equation 22 may be a best compromise because the results are in a reasonable range. However, Equation 22 may be manipulated further using Equation (law) 15 to yield Equation 23 as follows:

$$\frac{A}{{[ \frac{A}{B} ]}^{( \frac{{N}_{Max} - N}{{N}_{Max} - 1} )}} = {[ {A}^{( N - 1 )} {B}^{( {N}_{Max} - 1 )} ]}^{( \frac{1}{{N}_{Max} - 1} )} \qquad Eq . ( 23 )$$

Finally using Equation (law) 16, Equation 23 may be manipulated to yield Equation 24 as follows:

$$\frac{A}{{[ \frac{A}{B} ]}^{( \frac{{N}_{Max} - N}{{N}_{Max} - 1} )}} = {[ {A}^{( N - 1 )} {B}^{( {N}_{Max} - 1 )} ]}^{( \frac{1}{{N}_{Max} - 1} )} \qquad Eq . ( 24 )$$

Using the result in Equation 22, Equation 10 may be changed to Equation 25 as follows:

$$G {S}_{N} = {( {2}^{{N}_{N e w}} - 1 ) [ \frac{{{[ A ]}^{( \frac{N - 1}{{N}_{Max} - 1} )} [ B ]}^{( \frac{{N}_{Max} - N}{{N}_{Max} - 1} )} - {L}_{B G}}{{L}_{DMax}} ]}^{( \frac{1}{{γ}_{D}} )} \qquad Eq . ( 25 )$$

The L_{DMax} term in the denominator of Equation 25 may be brought outside of the parentheses as shown in Equation 26 as follows:

$$G {S}_{N} = ( {2}^{{N}_{N e w}} 1 ) {{L}_{DMax}^{( - 1 / {γ}_{D} )} [ {{[ A ]}^{( \frac{N - 1}{{N}_{Max} - 1} )} [ B ]}^{( \frac{{N}_{Max} - N}{{N}_{Max} - 1} )} - {L}_{B G} ]}^{( \frac{1}{{γ}_{D}} )} \qquad Eq . ( 26 )$$

$$Where :$$

$$A = {L}_{Max} = {L}_{DMax} + {L}_{B G} .$$

$$B = {L}_{Min} = {{B}_{O} ( {L}_{B G} )}^{C} + {L}_{B G} .$$

N=input gray shade number 1-255.
N_{Max}=maximum input gray shade determined from the input video chronometric data.
γ_{D}=gamma of the target display.
L_{DMax}=maximum display luminance (nits).
L_{BG}=reflected background luminance on the display (nits).
B_{O}=Fechner offset constant.
c=Fechner slope constant.
N_{New}=new 10 bit or 11 bit value for the target display including FRC.
GS_{N}=new mapped gray level value.

Equation 26 may provide the basis for a simplified implementation compared to Equation 10. Equation 27 may be formulated from Equation 26 by substituting L_{Max} and L_{Min} for the variables “A” and “B” respectively.

$$G {S}_{N} = ( {2}^{{N}_{N e w}} - 1 ) {{L}_{DMax}^{( - 1 / {γ}_{D} )} [ {{[ {L}_{Max} ]}^{( \frac{N - 1}{{N}_{Max} - 1} )} [ {L}_{Min} ]}^{( \frac{{N}_{Max} - N}{{N}_{Max} - 1} )} - {L}_{B G} ]}^{( \frac{1}{{γ}_{D}} )} \qquad Eq . ( 27 )$$

$$Where :$$

$${L}_{Max} = {L}_{DMax} + {L}_{B G}$$

$${L}_{Min} = {{B}_{O} ( {L}_{B G} )}^{C} + {L}_{B G}$$

Another way to think about the system is that the maximum (L_{Max}) and minimum (L_{Min}) luminance end point values are determined based on the filtered light sensor value. Equation 26 then calculates all of the new 10-bit or 11-bit values between the minimum and maximum end points. The result of using equation 26 is that successive intermediate gray scale values may have a constant visual contrast ratio that includes the effect of the reflected ambient light (L_{BG}). A new look up table generated by using equation 27 may be used to convert 8-bit video input gray shades to 10-bit or 11-bit video gray shade output values.

An example of a partial look up table is shown in Table 1 using the following inputs.
N_{Max}=255
γ_{D}=2.2
L_{DMax}=1000 nits
L_{BG}=100 nits
B_{O}=11
c=0.273
N_{New}=10 bit

TABLE 1
Look up table example

| N | GS_{N} |
|---|---|
| 0 | 230 |
| 1 | 233 |
| 2 | 237 |
| 3 | 240 |
| 4 | 243 |
| 5 | 246 |
| 6 | 249 |
| 7 | 252 |
| 8 | 255 |
| 9 | 258 |
| 10 | 261 |
| . . . | . . . |
| 248 | 995 |
| 249 | 999 |
| 250 | 1003 |
| 251 | 1007 |
| 252 | 1012 |
| 253 | 1016 |
| 254 | 1020 |
| 255 | 1024 |

An alternative formula that may be utilized for equation 27 is based on calculating the ratio once and then multiplying the ratio N−1 times the L_{Min} term. The ratio between adjacent gray shade levels is given by equation 28 as follows:

$$R = {[ \frac{{L}_{Max}}{{L}_{Min}} ]}^{( \frac{1}{{N}_{Max} - 1} )} \qquad Eq . ( 28 )$$

Therefore the selected gray shade luminance, Lₛₑₗ, may be determined per equation 29 as follows:

$${L}_{s e l} = {R}^{( N - 1 )} {L}_{Min} \qquad Eq . ( 29 )$$

However Lₛₑₗ includes the background luminance, L_{BG}, that may be subtracted out and equated to the target display luminance and resolution per equation 30 as follows:

$${{L}_{DMax} ( \frac{G {S}_{N}}{{2}^{N} N e w - 1} )}^{{γ}_{D}} = {R}^{( N - 1 )} {L}_{Min} {L}_{B G} \qquad Eq . ( 30 )$$

Solving for GS_{N} yields equation 31 as follows:

$$G {S}_{N} = ( {2}^{{N}_{N e w}} - 1 ) {{L}_{DMax}^{( - 1 / {γ}_{D} )} [ {R}^{( N - 1 )} {L}_{Min} - {L}_{B G} ]}^{( \frac{1}{{γ}_{D}} )} \qquad Eq . ( 31 )$$

Where R is defined in equation 28.

### Output Gray Shade Resolution:

An aspect to accomplish AIE-LVE compensation is to increase the display resolution in order to prevent banding due to rounding. For example, an 11-bit resolution may be appropriate to avoid seeing image artifacts.

### AIE-LVE Gamma Equation:

Although the previously described concept of using user perceived constant contrast ratios is a desired method to make all shades equally visible to the user, an alternative method is to use an offset gamma function.

FIG. 6 illustrates a graph 160 of a first example offset gamma curve in accordance with one or more exemplary embodiments. As shown in the figure, a bottom of the gamma curve 164 is offset from zero so that black shades become visible and the rest of the shades are determined according to the gamma function. The offset between the curve 162 and the curve 164 is due to the reflected background luminance.

The gamma curve method may start based on equation 32 as follows:

$${{L}_{DMax} ( \frac{G {S}_{N}}{{2}^{N} N e w - 1} )}^{{γ}_{D}} = ( {L}_{Max} - {L}_{Min} ) {( \frac{N}{{N}_{Max}} )}^{{γ}_{G}} + ( {L}_{Min} - {L}_{B G} ) \qquad Eq . ( 32 )$$

Where: N=0:N_{Max} (Input video gray shade numbers);
GS_{N}=new gray shade values.
N_{Max}=maximum input gray shade determined from the input video image gray shade histogram data;
N_{New}=Bit level of the output gray shades such as 8 or 10 bits;
Note that the gammas have different subscripts to convey that γ_{D}=target display gamma (usually 2.2); and
γ_{G}=new desired gamma.

Equation 32 may be solved for the new gray shade numbers GS_{N} as shown in equation 33 as follows:

$$G {S}_{N} = ( {2}^{{N}_{N e w}} - 1 ) {{L}_{DMax}^{( - 1 / {γ}_{D} )} [ ( {L}_{Max} - {L}_{Min} ) {( \frac{N}{{N}_{Max}} )}^{{γ}_{G}} + ( {L}_{Min} - {L}_{B G} ) ]}^{( \frac{1}{{γ}_{D}} )} \qquad Eq . ( 33 )$$

Using the L_{Min} definition in Equation 26, the term (L_{Min}−L_{BG})=B_{O}(L_{BG})^{c}, equation 33 becomes equation 34 as follows:

$$G {S}_{N} = ( {2}^{{N}_{N e w}} ) {{L}_{DMax}^{( - 1 / {γ}_{D} )} [ ( {L}_{Max} - {L}_{Min} ) {( \frac{N}{{N}_{Max}} )}^{{γ}_{G}} + {{B}_{O} ( {L}_{B G} )}^{c} ]}^{( \frac{1}{{γ}_{D}} )} \qquad Eq . ( 34 )$$

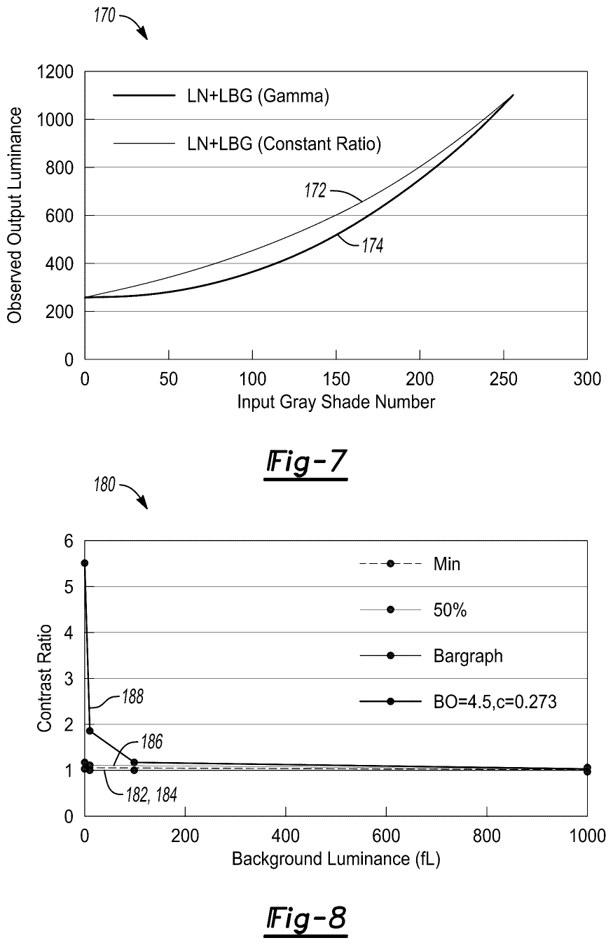

FIG. 7 illustrates a graph 170 of a comparison between the constant contrast ratio method (e.g., curve 172) and the gamma method (e.g., curve 174) in accordance with one or more exemplary embodiments.

B_{O} and c Constants Analysis:

The selection of the offset, B_{O}, and slope, c, constants may be approached with a further study of the Burnette data. Since increasing the LVE increases black levels to the visibility threshold and reduces the amount of image AIE stretching, the goal is to increase the lowest-black gray shades (but not pure black gray shade 0) to the level of visibility. Therefore, the analysis may start by investigating three categories on the Burnette plot: Minimum threshold legibility; 50% threshold legibility; and bargraph 99% legibility (note that lower gray shades are not normally used for numeric data).

Table 2 shows some estimated values. As an example, for the bargraph data, Burnette indicates that where the reflected background luminance is 100 fL, a display bargraph luminance of only 6.3 fL is visible 99% of the time.

TABLE 2
Data Points Estimated from Burnette Plot

| | L_{BG} (fL) | ESL (fL) |
|---|---|---|
| Minimum threshold legibility | 10 | 0.0794 |
| Minimum threshold legibility | 100 | 0.5 |
| 50% threshold legibiltiy | 1 | 0.05 |
| 50% threshold legibility | 10 | 0.316 |
| Bargraph 99% legibility | 10 | 1 |
| Bargraph 99% legibility | 100 | 6.3 |

### Minimum Threshold Legibility:

Equation 35 and equation 36 may be formulated for the data in Table 2 as follows:

$$0.0794 = {{B}_{O} ( 10 )}^{C} \qquad Eq . ( 35 )$$

$$0.5 = {{B}_{O} ( 100 )}^{C} \qquad Eq . ( 36 )$$

Dividing equation 36 by equation 35 yields equation 37 as follows:

$$\frac{0.5}{0.0794} = \frac{10 {0}^{C}}{1 {0}^{C}} \qquad Eq . ( 37 )$$

Equation 37 may be rewritten as equation 38 as follows:

$$\frac{0.5}{0.0794} = 10 {0}^{C} 1 {0}^{- 1 \times C} = {[ 100 \times 1 {0}^{- 1} ]}^{C} = {[ \frac{100}{10} ]}^{C} \qquad Eq . ( 38 )$$

Taking the logarithm of equation 38 results in equation 39 as follows:

$$log ( \frac{0.5}{0.0794} ) = log ( {[ \frac{100}{10} ]}^{C} ) = C \times log ( \frac{100}{10} ) \qquad Eq . ( 39 )$$

Since the log of 10 is equal to 1, equation 39 simplifies to equation 40 as follows:

$$c = log ( \frac{0.5}{0.0794} ) = 0.799 \qquad Eq . ( 40 )$$

Using the value of c determined in equation 40, equation 36 may be used to solve for the offset constant B_{O} per equation 41 as follows:

$${B}_{O} = \frac{0.5}{10 {0}^{0.799}} = 0.0126 \qquad Eq . ( 41 )$$

Therefore equation 1 may be written as equation 42, as follows:

$$E S L = 0.0126 {( {L}_{B G} )}^{0.799} \qquad Eq . ( 42 )$$

### 50% Threshold Legibility:

Using the methods described above and the values from Table 2, a 50% threshold legibility equation 43 may be determined as follows:

$$E S L = 0.05 {( {L}_{B G} )}^{0.8} \qquad Eq . ( 43 )$$

### Bargraph 99% Legibility:

Using methods described above and the values from Table 2, a bargraph 99% legibility equation 44 may be determined as follows:

$$E S L = 0.159 {( {L}_{B G} )}^{0.799} \qquad Eq . ( 44 )$$

A next step is to convert the equations 42, 43, and 44 from Imperial footlambert (fL) units to SI nit (cd/m²) units. The slope constant does not change between Imperial and SI units and only the offset constant B_{O} changes. To keep track of the unit system the labels B_{OfL} and B_{ONit} may be utilized. The conversion process starts with writing the general equation in Imperial fL units per equation 45 as follows. Note that equations 42, 43, and 44 are in imperial units.

$$E S {L}_{Nit} = {{B}_{ONit} ( {L}_{BGNit} )}^{C} \qquad Eq . ( 45 )$$

A relationship between a footlambert and nits are shown in equation 46 as follows:

$$1 f L = 3.42 Nits \qquad Eq . ( 46 )$$

Therefore to convert equation 45 to Imperial fL units, equation 47 may be written as follows:

$${ESL}_{fL} ( \frac{3.42 Nits}{1 fL} ) = {{B}_{ONit} ( {L}_{BGfL} [ \frac{3.42 Nits}{1 fL} ] )}^{C} \qquad Eq . ( 47 )$$

Therefore equation 47 may be changed to equation 48 and simplified to equation 49 as follows:

$$E S {L}_{fL} = {B}_{ONit} [ \frac{3.4 {2}^{C}}{3.42} ] {( {L}_{BGfL} )}^{C} \qquad Eq . ( 48 )$$

$${ESL}_{fL} = {B}_{ONit} {3.42}^{( C - 1 )} {( {L}_{BGfL} )}^{C} \qquad Eq . ( 49 )$$

Therefore to change from Nits to fL, the offset constant B_{ONit} is multiplied by the factor 3.42^{(C-1)}.

Conversely, to change from fL to Nits, equation 50 may be written as follows:

$${ESL}_{fL} = {{B}_{OfL} ( {L}_{BGfL} )}^{C} \qquad Eq . ( 50 )$$

Equation 50 may be rewritten as equation 51 using the conversion factor per equation 46 as follows:

$$E S {L}_{Nit} ( \frac{1 fL}{3.42 Nits} ) = {B}_{OfL} {( {L}_{BGNit} [ \frac{1 fL}{3.42 Nits} ] )}^{C} \qquad Eq . ( 51 )$$

Therefore equation 51 may be rearranged per equation 52 and simplified to equation 53 as follows:

$${ESL}_{Nit} = {B}_{OfL} [ \frac{3.42}{3.4 {2}^{C}} ] {( {L}_{BGNit} )}^{C} \qquad Eq . ( 52 )$$

$${ESL}_{Nit} = {B}_{OfL} {3.42}^{( 1 - C )} {( {L}_{BGNit} )}^{C} \qquad Eq . ( 53 )$$

Therefore, to change from the footlambert equation to the nit equation, the offset constant B_{OfL} is multiplied by the factor 3.43^{(1-C)}.

Using the conversion factor per equation 52, equations 42, 43, and 44 may be converted from Imperial to SI units per the following equations 54, 55, 56, 57, 58, and 59.

### Minimum Threshold Legibility:

$${ESL}_{Nit} = 0.0 \; 126 [ \frac{3.42}{3.4 {2}^{0.799}} ] {( {L}_{BGNit} )}^{0.799} \qquad Eq . ( 54 )$$

$${ESL}_{Nit} = 0.01 \; 6133 {( {L}_{BGNit} )}^{0.799} \qquad Eq . ( 55 )$$

### 50% Threshold Legibility:

$$E S {L}_{Nit} = 0.05 [ \frac{3.42}{3.4 {2}^{0.8}} ] {( {L}_{BGNit} )}^{0.8} \qquad Eq . ( 56 )$$

$${ESL}_{Nit} = 0.0 \; 6394 {( {L}_{BGNit} )}^{0.8} \qquad Eq . ( 57 )$$

### Bargraph 99% Legibility:

$${ESL}_{Nit} = 0.1 \; 59 [ \frac{3.42}{3.4 {2}^{\text{.799}}} ] {( {L}_{BGNits} )}^{0.799} \qquad Eq . ( 58 )$$

$${ESL}_{Nit} = 0.20 \; 3581 {( {L}_{BGNits} )}^{0.799} \qquad Eq . ( 59 )$$

Note that the offset and slope constants are different than the values used earlier where c=0.273 and B_{O}=11 (nits), 4.5 (fL) and as shown in equations 60, 61 and 62 as follows:

$${ESL}_{Nit} = 11 {( {L}_{BGNits} )}^{0.273} \qquad Eq . ( 60 )$$

$${ESL}_{fL} = 11 ( 3.4 {2}^{( 0.273 - 1 )} ) {( {L}_{BGfL} )}^{0.273} \qquad Eq . ( 61 )$$

$${ESL}_{fL} = 4.5 {( {L}_{BGfL} )}^{0.273} \qquad Eq . ( 62 )$$

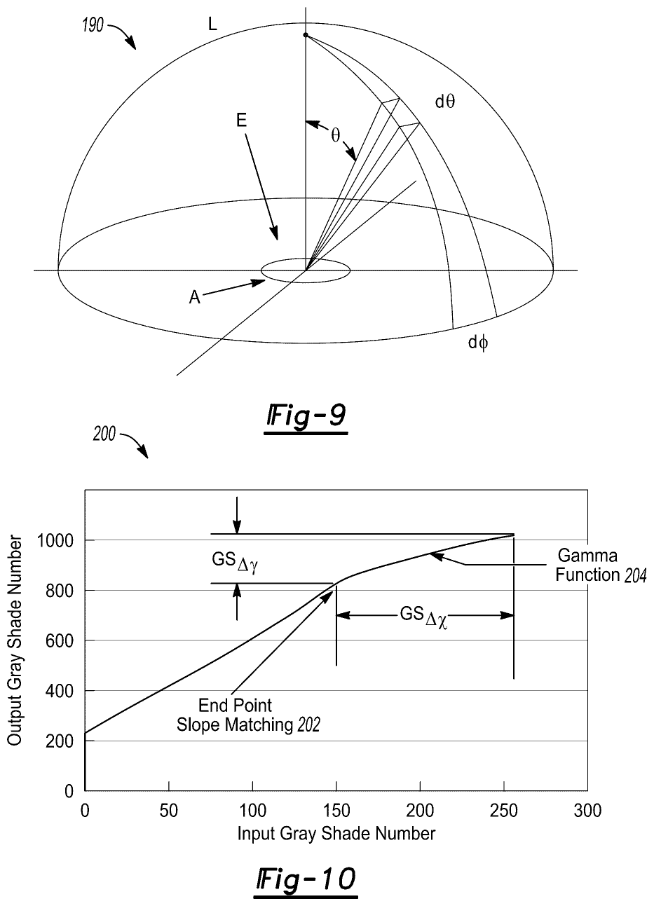

If the various equations are analyzed in terms of contrast ratio, FIG. 8 and Table 3 result.

FIG. 8 illustrates a graph 180 of a contrast ratio as a function of background luminance in accordance with one or more exemplary embodiments. Table 3 provides contrast ratio versus background luminance.

TABLE 3
Contrast Ratio versus Background Luminance (fL)

| L_{BGfL} | Min | 50% | Bargraph | B_{O} = 4.5, c = 0.273 |
|---|---|---|---|---|
| 1 | 1.0126 | 1.05 | 1.159 | 5.5 |
| 10 | 1.007932 | 1.031548 | 1.100091 | 1.843748 |
| 100 | 1.004993 | 1.019905 | 1.063008 | 1.158202 |
| 1000 | 1.003143 | 1.012559 | 1.039664 | 1.029663 |

Line 182 illustrates the Min column. Line 184 illustrates the 50% column. Line 186 illustrates the Bargraph column, Line 188 illustrates the B_{O}/c column. From Table 3, although Burnette predicts visibility at lower emitted symbol luminance values, the contrast ratios are away from ISO 15008 recommendations of 5:1 for night conditions, 3:1 for twilight conditions, 3:1 for day conditions, and 2:1 for direct sunlight conditions. To determine the various luminance categories, a model is used that converts lux illuminance levels to background luminance that the user sees on the display.

FIG. 9 illustrates a graph 190 of an example illuminance inside an integrating hemisphere in accordance with one or more exemplary embodiments. The inside of a cockpit may be thought of as an integrating hemisphere with uniform wall luminance L as shown in FIG. 9. Although many different actual reflection components exist in an automotive cockpit, many of such sources that are not at the specular or within the haze angles may be thought of as being in the diffuse Lambertian reflection component region. Consequently, the exact angles are not consequential of all sources that are not in the haze/specular region. The amount of sources in the haze region generally subtends a relatively small solid angle and, therefore generally does not need to be subtracted to obtain the Lambertian diffuse component seen by the user. Note that once that illuminance sources are at angles greater than the haze angle, the diffuse reflectance, ρ_{d}, is constant (e.g., flat) and may not be dependent on the angle from the specular reference angle. Therefore, all sources greater than the haze angle may be combined into one hemispherical reflection luminance that is the total illuminance, E lux, times the reflectance, ρ_{d} divided by π.

The amount of illuminance on a small area, A, at a center of the integrating hemisphere is given by equation 63 as follows:

$$E = \int d E = L {\int }_{0}^{2 π} d φ {\int }_{0}^{π / 2} cos θ sin θ d θ = 2 π L {\int }_{0}^{1} u d u = π L \qquad Eq . ( 63 )$$

The meaning of equation 63 is that if the cockpit interior is of uniform luminance, L (measured with a photometer in cd/m² SI units), then the amount of illuminance, E (lux in SI units), measured at the display is πL. As long as the total illuminance, E, and the diffuse Lambertian reflectance factor (coefficient), R (ρ_{d}), are known, then the amount of light seen by the user is given per equation 64 as follows:

$${L}_{User} = {ρ}_{d} \frac{E}{π} \qquad Eq . ( 64 )$$

Generally, the amount of illuminance, E, in automotive cockpit interiors is estimated to be about 5000 lux per standard J1757-1 (16, section 4.1). Furthermore, measuring the maximum illuminance E at the display with a cosine corrected illuminance meter when the sun is illuminating the interior such as through the front windscreen is desirable. Light colored interiors (e.g., more towards white) may demonstrate a higher illuminance, E, than darker interiors (e.g., black).

Therefore, assuming a reflection rate of 1.5% for a typical high performance anti-reflective coated display, and a 5000 lux interior illuminance (e.g., sunlight condition), the background luminance may be determined per equation 65 as follows:

$${L}_{B G} = 0.015 \frac{5000 lux}{π} = 24 nits \qquad Eq . ( 65 )$$

Therefore, to meet the ISO 15008 contrast ratio recommendation of 3:1, the display luminance may be 48 nits.

For nighttime illuminance of about 10 lux, the background luminance may be determined per equation 66 as follows:

$${L}_{B G} = 0.015 \frac{10 lux}{π} = 0.05 nits \qquad Eq . ( 66 )$$

Therefore, to meet the ISO 15008 contrast ratio recommendation of 5:1, the display luminance may be 0.2 nits.

Therefore, the equations 65 and 66 may be written as equations 67 and 68 as follows:

$$48 = {B}_{O} {( 24 )}^{C} \qquad Eq . ( 67 )$$

$$0.2 = {B}_{O} {( 0.05 )}^{C} \qquad Eq . ( 68 )$$

Solving the equations 67 and 68 yields equations 69 and 70 as follows:

$$ES {L}_{Nit} = 2.86 {( {L}_{BGNits} )}^{0.887} \qquad Eq . ( 69 )$$

$${ESL}_{fL} = 0.87 {( {L}_{BGfL} )}^{0.887} \qquad Eq . ( 70 )$$

Due to the aggressive nature of the ISO 15008 results, the constants per equation 70 meet the ISO 15008, but may only be used on a display with a low reflectance rate because the lower gray shade luminance increases dramatically for background luminances greater than 100 nits and may consume the available AIE stretching range. A lower slope constant may be considered for displays with higher reflectance rates greater than 1.5%, because the lower gray shades may still be visible according to the Burnette data.

### AIE End Point Enhancement:

The AIE stretching function may have some luminance overhead such that pixels that exceed the threshold limit may be differentiated to some degree, instead of limiting such pixels to the same peak display luminance value. The overhead generally subtracts from the dynamic range of the stretched portion. In various embodiments, the feasibility of specifying the overhead makes a modification to equation 27 where the maximum display luminance used for L_{Max} is less than the display maximum luminance of L_{DMax}. Therefore, if a % End Point Overhead, %_{EPOH}, is employed, a new display limit luminance, L_{DLimit}, may be specified per equation 71 as follows:

$${L}_{DLimit} = ( 100 \% - {\%}_{EPOH} ) \times {L}_{D Max} \qquad Eq . ( 71 )$$

However, the amount of overhead may be adjusted automatically so that as N_{Max} approaches 255, the amount of overhead is reduced per Equation 72 as follows:

$${L}_{DLimit} = ( 100 \% - {\%}_{EPOH} [ \frac{255 - {N}_{Max}}{255} ] ) \times {L}_{D Max} \qquad Eq . ( 72 )$$

So, for example, if an overhead is desired for all gray levels over the threshold, the stretching may be limited according to Equation 72. The method to accomplish the limiting is to modify Equation 27 to become Equation 73 as follows:

$$G \text{} {S}_{N} = \text{} ( {2}^{{N}_{N e w}} - 1 ) \text{} {{L}_{D Max}^{( - 1 / {γ}_{D} )} [ [ {L}_{Max} ] {( \frac{N - 1}{{N}_{Max} - 1} )}_{[ {L}_{Min} ]} ( \frac{{N}_{Max} - N}{{N}_{Max} - 1} ) - {L}_{B G} ]}^{( \frac{1}{{γ}_{D}} )} \qquad Eq . ( 73 )$$

$$Where :$$

$${L}_{Max} = {L}_{DLimit} + {L}_{B G} ; and$$

$${L}_{Min} = {{B}_{O} ( {L}_{B G} )}^{C} + {L}_{B G} .$$

Note that L_{DMax} may be used in the Equation 73. Therefore, the Equation 73 sets the maximum display luminance to be L_{DLimit} where N=N_{Max}.

There are several way to use the overhead luminance for the video pixels that are above the threshold: 1 set all pixels with luminances above the N_{Max} threshold to the maximum display luminance; 2 do a linear interpolation from the L_{DLimit}, N_{Max} point to the L_{DMax}, 255 point; and 3 use a function to match the slope of the L_{DLimit}, N_{Max} point and try to hide the demarcation of the L_{DLimit}, N_{Max} point.

A function that may be used for the third method is the gamma function. The gamma function, as shown in Equation 74, has the desirable attributes of:
GS_{ΔyN}=0 where GS_{ΔxN}=0
GS_{ΔyN}=GS_{Δy} where GS_{ΔxN}=GS_{Δx}

The γ_{EP} may be used to change the initial slope of the function

$$G {S}_{Δ y N} = G {S}_{Δ y} {( \frac{G {S}_{Δ x N}}{G {S}_{Δ x}} )}^{{γ}_{E P}} \qquad Eq . ( 74 )$$

FIG. 10 illustrates a graph 200 of an example end point slope gamma matching function at an end point 202 in accordance with one or more exemplary embodiments. In the example, the luminance overhead is set at 90% and there is a 100 nit background luminance level. In addition, the input gray scale threshold is determined by the histogram data to be set at 150. So although the gray shades above 150 are compressed (e.g., line 204), the higher gray shade pixels may be differentiated among each other instead of being clipped to the same maximum luminance value.

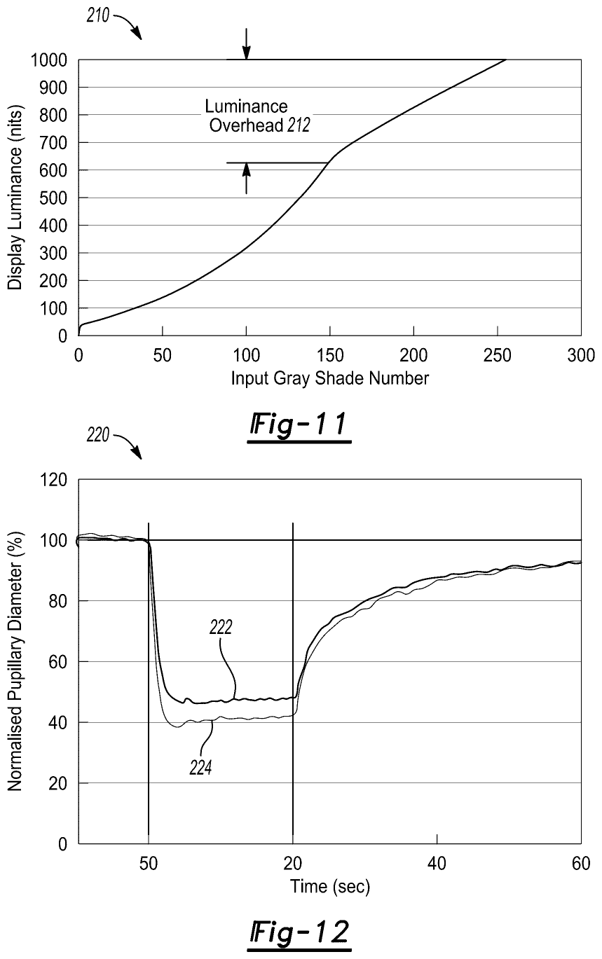

FIG. 11 illustrates a graph 210 of an example of a display luminance with end point slope gamma matching function in accordance with one or more exemplary embodiments. The graph 210 generally illustrates conversion results of the target display luminance values shown in FIG. 10.

The sequence of calculations used to implement the end point slope gamma matching function may be as follows:

Step 1: Calculate the end point output gray shade number.

Equation 75 may be utilized to determine the end point output gray shade number, GS_{NEP}, as follows:

$$\begin{matrix}{L}_{DLimit} = ( 100 \% - {\%}_{EPOH} [ \frac{255 - {N}_{Max}}{255} ] ) \times {L}_{D Max} \\ = {L}_{D Max} {( \frac{G {S}_{NEP}}{{2}^{10} - 1} )}^{γ}\end{matrix} \qquad Eq . ( 75 )$$

Solving for GS_{N} yields Equation 76 as follows:

$$G {S}_{NEP} = {( {2}^{10} - 1 ) [ 100 \% - {\%}_{EPOH} ( \frac{255 - {N}_{Max}}{255} ) ]}^{( \frac{1}{γ} )} \qquad Eq . ( 76 )$$

For the example above per FIG. 11, with an overhead luminance 212 defined as 90% and N_{Max}=150, the result is shown in Equation 77 as follows:

$${GS}_{NEP} = {( {2}^{10} - 1 ) [ 100 \% - {\%}_{EPOH} ( \frac{255 - {N}_{Max}}{255} ) ]}^{( \frac{1}{γ} )} \qquad Eq . ( 77 )$$

$${GS}_{NEP} = ( 10 \; 23 ) {( 100 \% - 37.06 \% )}^{( \frac{1}{2.2} )} = 828.862$$

Therefore, a 10-bit output end point is at y=GS_{NEP}=828.862. This value may be available in the assignment table generated per Equation 73 because N=N_{Max}. Note that non-rounded values are used to determine the slope.

Step 2: Determine the slope of the end point, S_{E}.

The slope of the end point of the gray scale curve as shown in FIG. 10 may be determined by starting with Equation 78 as follows:

$${S}_{E} = \frac{Δ y}{Δ x} = \frac{G {S}_{NEP} - G {S}_{NEP - 1}}{{N}_{Max} - ( {N}_{Max} - 1 )} = G {S}_{NEP} - G {S}_{NEP - 1} \qquad Eq . ( 78 )$$

Where GS_{NEP-1} is the output gray shade associated with input gray shade N_{Max-1}. Therefore Equation 73 may be modified as Equation 79 to solve for GS_{NEP-1} as follows:

$${GS}_{NEP - 1} = ( {2}^{{N}_{New}} - 1 ) {{L}_{DMax}^{( - 1 / {γ}_{D} )} [ {{[ {L}_{Max} ]}^{( \frac{{N}_{Max} - 1 - 1}{{N}_{Max} - 1} )} [ {L}_{Min} ]}^{( \frac{{N}_{Max} - ( {N}_{Max} - 1 )}{{N}_{Max} - 1} )} - {L}_{BG} ]}^{( \frac{1}{{γ}_{D}} )} \qquad Eq . ( 79 )$$

Using the result from Equation 79, the slope may be determined per Equation 78. Note that GS_{NEP-1} is the next lowest from N_{Max} non-round value in the assignment table. Using the following values for the example shown in FIG. 10, the value for GS_{NEP-1} may be determined per Equation 80 as follows:

$${GS}_{NEP - 1} = 824.008 \qquad Eq . ( 80 )$$

Where:
L_{BG}=100 nits.
L_{DMax}=1000 nits.
c=0.273.
B_{O}=11 nits.
N_{Max}=15.

Therefore the slope, S_{E}, may be calculated per Equation 81 as follows:

$${S}_{E} = 828.862 - 824.008 = 4.855 \qquad Eq . ( 81 )$$

Step 3: Calculate γ_{EP}:

Using Equation 74, the slope for the first step in the gamma curve is determined per Equation 82 as follows:

$${S}_{γ} = \frac{{{GS}_{Δ y} ( \frac{1}{{GS}_{Δ x}} )}^{{γ}_{EP}} - {{GS}_{Δ y} ( \frac{0}{{GS}_{Δ x}} )}^{{γ}_{EP}}}{1 - 0} \qquad Eq . ( 82 )$$

$${S}_{γ} = {{GS}_{Δ y} ( \frac{1}{{GS}_{Δ x}} )}^{{λ}_{EP}}$$

Setting S_{γ}=S_{E} yields Equation 83 as follows:

$${S}_{E} = {{GS}_{Δ y} ( \frac{1}{{GS}_{Δ x}} )}^{{γ}_{EP}} \qquad Eq . ( 83 )$$

Equation 83 may be rearranged to provide Equation 84 as follows:

$${( \frac{1}{{GS}_{Δ x}} )}^{{γ}_{EP}} = \frac{{S}_{E}}{{GS}_{Δ y}} \qquad Eq . ( 84 )$$

Taking the logarithm of both sides of Equation 84 yields Equation 85 as follows:

$${γ}_{EP} log ( \frac{1}{{GS}_{Δ x}} ) = log ( \frac{{S}_{E}}{{GS}_{Δ y}} ) \qquad Eq . ( 85 )$$

Solving for γ_{EP} gives Equation 86 as follows:

$${γ}_{EP} = \frac{log ( \frac{{S}_{E}}{{GS}_{Δ y}} )}{log ( \frac{1}{{GS}_{Δ x}} )} \qquad Eq . ( 86 )$$

Manipulating Equation 86, yields Equation 87 as follows:

$${γ}_{EP} = \frac{log ( \frac{{S}_{E}}{{GS}_{Δ y}} )}{log ( 1 ) - log ( {GS}_{Δ x} )} \qquad Eq . ( 87 )$$

Since the log(1)=0, Equation 87 may be simplified to Equation 88 as follows:

$${γ}_{EP} = \frac{- log ( \frac{{S}_{E}}{{GS}_{Δ y}} )}{log ( {GS}_{Δ x} )} \qquad Eq . ( 88 )$$

For the example provided in FIG. 10, the T_{EP} may be determined per Equation 89 as follows:

$${γ}_{EP} = \frac{- log ( \frac{4.855}{1023 - 828.862} )}{log ( 255 - 150 )} = 0.792576 \qquad Eq . ( 89 )$$

Therefore, the final gamma function that is added to the end point is given per Equation 90 as follows:

$${F}_{{γ}_{EP}} = {{GS}_{Δ y} ( \frac{{GS}_{Δ xN}}{{GS}_{Δ x}} )}^{{γ}_{EP}} \qquad Eq . ( 90 )$$

For GS_{ΔxN}=0:(255−N_{Max}), Equation 90 becomes Equation 91 as follows:

$${F}_{{γ}_{EP}} = ( 1023 - 828.862 ) {( \frac{N}{255 - 150} )}^{0.792576} \qquad Eq . ( 91 )$$

For N=0:150, another way to write Equation 91 is per Equation 92 as follows:

$${F}_{{γ}_{EP}} = ( 1023 - 828.862 ) {( \frac{N - 150}{255 - 150} )}^{0.792576} \qquad Eq . ( 92 )$$

A more general form of Equation 92 is presented shown in Equation 93 as follows:

$${F}_{{γ}_{EP}} = ( {2}^{{N}_{New}} - 1 - {GS}_{NEP} ) {( \frac{N - {N}_{Max}}{255 - {N}_{Max}} )}^{{γ}_{EP}} \qquad Eq . ( 93 )$$

The Fγ_{EP} function may be add to the GS_{NEP} value from GS_{N}=N_{Max} to GS_{N}=255. Therefore for GS_{N}>GN_{EP}, the Equation 94 may be utilized.

$$G {S}_{N} = {GS}_{NEP} + ( {2}^{{N}_{N e w}} - 1 - {GS}_{NEP} ) {( \frac{N - {N}_{Max}}{255 - {N}_{Max}} )}^{{γ}_{E P}} \qquad Eq . ( 94 )$$

Where N=N_{Max}:255.

### AIE-LVE Inflection Point Modifier (IPM):

A method to implement the Inflection Point Modifier may be to use a sine wave concept with one phase before the inflection point gray shade number, N_{I}, and a second phase after the inflection point. The basic concept is to multiply the original assignment table output gray scale numbers by the sine wave and then add the result to the original assignment table output gray shade numbers. The Equations for the two phases are shown in Equations 95 and 96 as follows:

$${F}_{IPMPhase 1} = {A}_{1} sin ( \frac{π \times {GS}_{N}}{{N}_{I}} ) \qquad Eq . ( 95 )$$

$${F}_{IPMPhase 2} = {A}_{2} sin ( \frac{π \times ( {GS}_{N} - {N}_{I} )}{{N}_{Max} - {N}_{I}} ) \qquad Eq . ( 96 )$$

Therefore, where the input gray shade number, GS_{N}, is less than or equal to the inflection gray shade number, N_{I}, Equation 95 is utilized to multiply each of the original output gray shade values and the result is added to the original output gray shade values. Where the input gray shade number, GS_{N}, is greater than the infection gray shade number, N_{I}, Equation 96 is utilized to multiply each of the original output gray shade values and the result is added to the original output gray shade numbers. Usually one of the two amplitudes is negative. In addition the inflection gray shade number may be structured to be a percentage of N_{Max} so that as N_{Max} changes dynamically for AIE the inflection point remains relatively in the correct location. Another structure that may be implemented is controlling the relative gains per Equation 97 such that the inflection magnitude for both phases remains relatively constant as follows:

$${A}_{2} = - ( \frac{{N}_{Max} - {N}_{I}}{{N}_{I}} ) {A}_{1} \qquad Eq . ( 97 )$$

### AIE-LVE Gamma Modifier:

The gamma modifier function generally consists of multiplying the delta of the output gray shades by the gamma function and adding back to the original output gray scale 0 output value. Assume that the nomenclature is that any subscript with an “O” is the output gray shade value. The value that follows the “O” is the corresponding input gray scale number in the assignment table. Therefore, as an example, GS_{O0} is the output gray scale value corresponding to the input gray shade number of 0 in the assignment table structure. Equation 98 is a form of a gamma modifier function as follows:

$$G {S}_{O N} = G {S}_{O 0} + ( {GS}_{ON} - {GS}_{O 0} ) {( \frac{G {S}_{N}}{{N}_{Max}} )}^{{γ}_{M}} \qquad Eq . ( 98 )$$

### Light Sensor Filter Factors:

FIG. 12 illustrates a graph 220 of an example pupillary light reflex (e.g., curve 224) to a blue light stimulus in accordance with one or more exemplary embodiments. The curve 222 is a control curve. The light sensor filter is based on Equation 99 where the F_{Up} and F_{Down} are used according to the following logic:
If L_{BGNew}>L_{BGOld}, F=F_{Up}; and
If L_{BGNew}<L_{BGOld}, F=F_{Down}.

$${L}_{B G} = \frac{{L}_{B G N e w} + ( F - 1 ) {L}_{BGOld}}{F} \qquad Eq . ( 99 )$$

As such, the response time for an increasing luminance may be controlled for about 1 second with an F=32 value and a loop time of 16.67 ms. For a decreasing luminance, a value of F=2048 may be used for a 90% to 10% fall time of about 75 seconds (e.g., approximately 60 seconds). The approach is used because the eye has about a 1 second rise time response and about a 60 second fall time response.

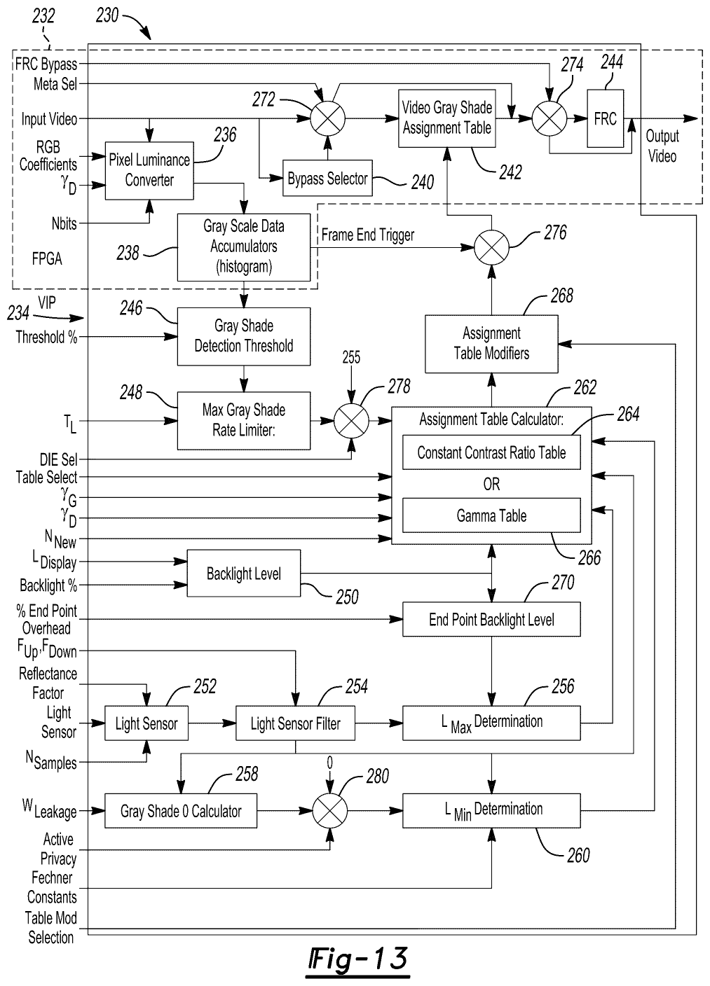

FIG. 13 illustrates an example intermediate functional block diagram of a system in accordance with one or more exemplary embodiments. In various embodiments, the diagram 230 may be implemented with a field programmable gate array (FPGA) or application specific integrated circuit (ASIC) 232 connected to a vehicle interface processor (VIP) 234 or other processor. Each of the blocks in the diagram are described as follows:

### Pixel Luminance Converter Block 236:

The pixel luminance converter block 236 converts every RGB pixel into a monochrome gray shade value based on Equation 100 where the RGB coefficients are (0.19, 0.68, 0.13).

$$\begin{matrix}{( \frac{G {S}_{M}}{G {S}_{Max}} )}^{γ} = 0.19 {( \frac{G {S}_{R}}{G {S}_{Max}} )}^{γ} \\ + 0.68 {( \frac{G {S}_{G}}{G {S}_{Max}} )}^{γ} \\ + 0.13 {( \frac{G {S}_{B}}{G {S}_{Max}} )}^{γ}\end{matrix} \qquad Eq . ( 100 )$$

Cancelling terms and solving for the equivalent monochrome gray shade results in Equation 101.

$$G {S}_{M} = {[ 0.19 {( G {S}_{R} )}^{γ} + 0.68 {( G {S}_{G} )}^{γ} + 0.13 {( G {S}_{B} )}^{γ} ]}^{( \frac{1}{γ} )} \qquad Eq . ( 101 )$$

### Gray Scale Data Accumulators Block 238:

Each pixel is converted into a monochrome gray scale value per Equation 101 and a value of 1 is added for each pixel to each corresponding gray scale accumulator consisting of GS_{Max} accumulators for each frame. For 8-bit video, this would use 256 accumulators. Histogram data is sent to the vehicle interface processor 234 at the end of each video frame. In addition, a Frame End Trigger (FET) is sent to the vehicle interface processor 234 indicating that the accumulators are ready to be down loaded to the vehicle interface processor 234. In addition, the frame end trigger is used to trigger the uploading of the AIE-LVE assignment table in preparation for the next frame of video conversion. Finally, the frame end trigger is used to signal that the new light sensor data is to be sampled. The light sensor sampling generally occurs once per frame cycle such that all functions used the same filtered data L_{BG} light sensor data for each frame.

### Metadata AIE-LVE Bypass Selector Block 240:

The function of bypass selector block 240 is to use the metadata embedded in the video stream to determine safety related or other video symbols to which the AIE-LVE enhancement is not to be applied. In this case, the AIE-LVE assignment table is not utilized and the video for the areas are sent directly to the display.

### Video Gray Shade Assignment Table Block 242:

The gray shade assignment table block 242 utilizes the AIE-LVE assignment table to convert the incoming video gray shade values into the enhanced video gray shade values. Table 1 is an example of a video look up table that is uploaded by the FPGA or ASIC 232 during the video vertical blanking time in preparation for the next active video time period. The output from the gray scale assignment table may be either 10-bit video or 11-bit video.

### 10-Bit or 11-Bit Frame Rate Control Block 244:

The frame rate control block 244 applies frame rate control (FRC) methods to convert the 10-bit (or 11-bit) video data to dithered 8-bit video.

### Gray Shade Detection Threshold Determination Block 246:

The gray shade detection threshold determination block 246 determines the maximum gray scale number such that a specific percentage of the pixels are above a threshold percentage according to Equation 102. Therefore, the method starts at a highest accumulator and keeps adding the next lower accumulator value until the threshold percentage is determined for the corresponding gray shade value. This is the GS_{Max} N value used for stretching the dynamic video range after being filtered into variable N_{Max} by the rate limiting filter per Block 7.

$$If [ \frac{SUM ( N : {N}_{Max} )}{SUM ( 0 : {N}_{Max} )} > \frac{{T}_{\%}}{100} , {GS}_{Max} = N ] \qquad Eq . ( 102 )$$

### Max Gray Shade Filter Block 248:

The filter block 248 is a rate limiter whereby the N_{Max} value in incremented or decremented by one gray shade value (8 bit) towards the GS_{Max} value each TL time increment. The rate of the filter is set by the TL time increment input.

### Backlight Level Block 250:

A commanded backlight pulse width modulation (PWM) level is obtained and used to determine the display luminance, L_{DMax}, per Equation 103 as follows, where LD is the display luminance at 100% backlight drive, % BL.

$${L}_{D Max} = {\%}_{B L} \times {L}_{D} \qquad Eq . ( 103 )$$

### Light Sensor Pre-Filter Block 252:

In response to the Frame End Trigger (FET), N samples of the light sensor are successively measured and averaged resulting in the variable L_{BGNew} per Equation 104 as follows:

$${L}_{B G N e w} = {R}_{F} \times AVG ( {N}_{Samples} ) \qquad Eq . ( 104 )$$

Note that the reflectance factor, RF, is used to determine how much of the light sensor value is reflected to the user and also to do any conversion to user observed nits.

### Light Sensor Filter Block 254:

The light sensor value obtained in block 252 is further filtered according to Equation 105 to obtain a faster exponential rise time of about 1 second than the fall time of about 60 seconds to mimic the eye adaptation times of the human visual system and to provide a peak detector function for the picket fence effects.

$${L}_{B G} = \frac{{L}_{B G N e w} + ( F - 1 ) {L}_{BGOld}}{F} \qquad Eq . ( 105 )$$

The F values are selected to be F_{Up} when the new light sensor value, L_{BGNew} is larger than the previous filtered value, L_{BGOld}, and F_{Down} where the new light sensor value, L_{BGNew} is smaller than the previous filtered value, L_{BGOld}. The time constant for the filter is selected for the 1 second rise time and 60 second fall time goal.

### L_{Max} Determination Block 256:

The user observed maximum luminance is determined per Equation 106, as follows, and is the summation of the end point display luminance (reference Block 270) and the reflected background luminance, L_{BG}, that the user sees.

$${L}_{Max} = {L}_{D L i m i t} + {L}_{B G} \qquad Eq . ( 106 )$$

L_{Max} is the higher end point for Equation 27 or Equation 34

### Gray Shade 0 Calculator Block 258:

Gray shade 0 (GS₀) needs to be handled as a special case. If there is no active privacy function on the display, GS₀ is set to 0 nits to obtain the appearance of a black display where no information is present. If the display does have the privacy function active, the GS₀ background luminance may be raised to reduce the contrast ratio of the image. In various embodiments, the Weber Fraction level may be less than 25 for low black luminance values.

The Weber Fraction is the amount of white crosstalk that the driver sees when observing the passenger display. The “Fraction” is the amount of white luminance seen divided by the black luminance that the driver sees as formulated per Equation 107 as follows:

$${W}_{F} = \frac{{W}_{L eakage}}{{L}_{GS 0} + {L}_{B G}} < 25 \qquad Eq . ( 107 )$$

Where:
W_{Leakage}=the amount of white leakage that the user sees;
L_{GS0}=the amount of display black luminance; and
L_{BG}=the amount of reflected background luminance that the user sees at night.

Equation 107 may be rearranged to yield Equation 108, as follows, that determines how much the display black luminance value may be increased to obtain a Weber Fraction of less than 25.

$${L}_{G S 0} > \frac{{W}_{Leakage}}{25} - {L}_{B G} \qquad Eq . ( 108 )$$

For proper operation in the formula for L_{Min}, L_{BG} is added to the display luminance to obtain L_{Min}. Therefore, to meet the Weber Fraction criteria, L_{Min} may be determined per Equation 109 as follows:

$${L}_{Min} > \frac{{W}_{Leakage}}{25} \qquad Eq . ( 109 )$$

Such a AIE-LVE implementation provides that the black level luminance, L_{GS0}, may be increased to meet the Weber Fraction requirement.

### L_{Min} Determination Block 260:

A minimum luminance level for the assignment table calculation is based on the larger of the Weber Fraction black luminance level calculated per Equation 110 or the minimum luminance level calculated for display visibility per Equation 111 as follows:

$${L}_{Min} = \frac{{W}_{L e a k a g e}}{25} \qquad Eq . ( 110 )$$

$${L}_{Min} = {{B}_{O} ( {L}_{B G} )}^{C} + {L}_{B G} \qquad Eq . ( 111 )$$

The Fechner offset B_{O} and slope c constants are used together with the background luminance, L_{BG}, to determine the minimum luminance, L_{Min}, that the user needs to barely perceive the lowest gray shade information values. L_{Min} is the lower end point for Equation 27 as depicted in FIG. 39. The minimum Fechner constant value may be calculated per Equation 112 as follows:

$${L}_{MinFechner} = {{B}_{O} ( {L}_{B G} )}^{C} + {L}_{B G} \qquad Eq . ( 112 )$$

### Assignment Table Calculator Block 262:

The assignment table calculation may have two parts. A first part is the calculation for the “black” level G_{S0} per Equation 113 as follows:

$$G {S}_{0} = ( {2}^{{N}_{New}} - 1 ) {{L}_{D Max}^{( - 1 / {γ}_{D} )} [ [ {L}_{G S 0} ] ]}^{( \frac{1}{{γ}_{D}} )} \qquad Eq . ( 113 )$$

A second calculation involves first choosing which assignment table calculation method may be utilized based on the “Table Select” command.
1. Constant Contrast Ratio Assignment Table 264; or
2. Gamma Assignment Table 266.

### Constant Contrast Ratio Assignment Table 264:

The process of calculating the intermediate input video gray shade values GS₁ through GS_{NMax} between L_{Min} and L_{Max} such that each successive gray shade has the same contrast ratio taking the reflected ambient into account the reflected ambient per Equation 114 as follows:

$${GS}_{N} = ( {2}^{{N}_{New}} - 1 ) {{L}_{DMax}^{( - 1 {γ}_{D} )} [ [ {L}_{Max} ] ( \frac{N - 1}{{N}_{Max} - 1} ) [ {L}_{Min} ] ( \frac{{N}_{Max} - N}{{N}_{Max} - 1} ) - {L}_{BG} ]}^{( \frac{1}{{γ}_{D}} )} \qquad Eq . ( 114 )$$

### Gamma Assignment Table 266:

The process of calculating the intermediate input video gray shade values GS₁ through GS_{NMax} between L_{Min} and L_{Max} such that each of the gray shades follow an offset gamma function are determined according to Equation 115 as follows:

$${GS}_{N} = ( {2}^{{N}_{New}} - 1 ) {{L}_{D Max}^{( - 1 / {γ}_{D} )} [ ( {L}_{Max} - {L}_{Min} ) {( \frac{N}{{N}_{Max}} )}^{{γ}_{G}} + ( {L}_{Min} - {L}_{BG} ) ]}^{( \frac{1}{{γ}_{D}} )} \qquad Eq . ( 115 )$$

### Assignment Table Modifiers Block 268:

Block 268 provides an assignment table developed per Block 262 and is modified by multiplying other shaping functions.

### End Point Backlight Level Block 270:

Block 270 provides some overhead luminance that may be used in conjunction with AIE. If AIE is not used, or no overhead is desired, the input variable “% End Point Overhead” is set to zero. The end point modifier function in Block 268 may be activated if the “% End Point Overhead” is not zero.

### Selector S1, Metadata Control:

The selector S1 block 272 has two functions. If the metadata control is activated, the metadata is used to either bypass the AIE-LVE video assignment table or use the assignment table as a function of the metadata. If the metadata control is deactivated, the assignment table is used for all video data.

### Selector S2, FRC Bypass Control:

The selector S2 block 274 controls whether the Frame Rate Control function is utilized. If the display has a native 10-bit or 11-bit video input, the FRC function may be bypassed.

### Selector S3, Assignment Table Upload Control:

The selector S3 block 276 is triggered to upload the video assignment table as a function of the Frame End Trigger (FET) emanating from the FPGA (or ASIC) when the last video pixel for the current frame has been received. The video assignment table is to be uploaded during the video vertical blanking time in preparation for the next frame.

### Selector S4, AIE Activation Control:

The selector S4 block 278 control activates the AIE stretching function. If AIE stretching is not activated, N_{Max} is set to 255 and therefore all input gray shades (e.g., 0-255) are formulated to have a constant contrast ratio or gamma offset between L_{Min} and L_{Max}. If however the AIE stretching function is activated, N_{Max} is set according to the filtered video accumulator threshold per Blocks 246 and 248.

### Selector S5, Active Privacy Control:

The selector S5 block 280 control is utilized to activate raising the black gray shade 0 luminance, L_{GS0}, to a level required to meet the Weber Fraction criteria. This has the effect of raising the black level for both the driver and the passenger. Since the black level luminance, L_{GS0}, is a function of the (ambient) light sensor determined background luminance, L_{BG}, per Equation 108, as the reflected background luminance increases towards daylight conditions, the black level luminance, L_{GS0}, is decreased such that under daytime conditions the black gray shade luminance is not increased.

### VIP and FPGA Input List and Description:

Table 4 is a tabulation of the various inputs to the AIE-LVE software (or code). The variables may be stored in a Variable Control Register (VCR) that may be changed via a controller area network (CAN) bus or other communication methods.

TABLE 4
VIP Input List Description

| I.D. | Name | Description |
|---|---|---|
| 0 | Threshold % | % of upper gray shade |
| | | pixels that are not |
| | | stretched by AIE. The |
| | | range for this variable is |
| | | 0% to 30% with a typical |
| | | value of 5%. |
| 1 | T_{L} | GS_{Max} rate limiter ΔT. |
| | | This is the time between |
| | | Incrementing or |
| | | decrementing the N_{Max} |
| | | towards GS_{Max}. This time |
| | | will be in the range of |
| | | 10 ms to 100 ms. The |
| | | default value should be |
| | | 10 ms |
| 2 | AE Sel | Enables or disables AIE |
| | | stretching function. |
| | | 0 = Disable and N_{Max} is set |
| | | to 255. 1 = Enable. The |
| | | default value should be 1. |
| 3 | γ_{D} | This is the gamma value |
| | | for the display which is |
| | | normally 2.2. The range |
| | | for this gamma will be |
| | | from 1 to 3 with two |
| | | decimal points. The |
| | | default value should be |
| | | 2.2. |
| 4 | N_{New} | This is the number of bits |
| | | for the output of the |
| | | assignment table |
| | | calculator (normally 10 or |
| | | 11). The selection should |
| | | be 8, 10, 11 or 12 bits. |
| | | The default value should |
| | | be 8 bits. |
| 5 | L_{Display} | Specifies the target display |
| | | luminance to the |
| | | algorithm. The range of |
| | | this variable will be 500 to |
| | | 1500 nits with 1000 nits as |
| | | the default value. |
| 6 | Backlight % | Specifies the backlight |
| | | PWM % commanded to |
| | | the display. This variable |
| | | will range from 0% to |
| | | 100% with 100% being |
| | | the default value. |
| 7 | F_{Up} | Filter Up weighting |
| | | number. For a 16.67 ms |
| | | frame loop time, the factor |
| | | will be 32 for a 10% to |
| | | 90% time of 1.2 seconds. |
| | | The range should be 16 to |
| | | 64 with increments of 16 |
| | | with the default value of |
| | | 32. |
| 8 | F_{Down} | Filter Down weighting |
| | | number. For a 16.67 ms |
| | | frame loop time, the factor |
| | | will be 2048 for a 90% to |
| | | 10% time of 75 seconds. |
| | | The range should be 256 |
| | | to 2304 with increments of |
| | | 256 with the default value |
| | | of 2048. |
| 9 | Reflectance | Display reflectance factor |
| | Factor | used with light sensor |
| | | input to determine the |
| | | reflected luminance that |
| | | the user sees in nit units. |
| | | The range of the |
| | | reflectance should be |
| | | 0.005 to 0.100 with 3 |
| | | decimal places and a |
| | | default value of 0.01. |
| 10 | Light Sensor | Light sensor input in Lux |
| | | units. This input will |
| | | range from 1 lux to 100K |
| | | lux with a default value of |
| | | 5K lux. |
| 11 | N_{Samples} | Number of samples to be |
| | | averaged by the pre-filter. |
| | | This number can range |
| | | from 4 to 32 by |
| | | increments of 4 and a |
| | | default value of 16. |
| 12 | W_{Leakage} | The amount of white |
| | | leakage that the driver sees |
| | | in privacy mode. The |
| | | amount can range from 0.1 |
| | | to 10 nits with a default |
| | | value of 0.75 nits. |
| 13 | Active | Conveys active privacy |
| | Privacy | mode to algorithm. 0 = No |
| | | Privacy. 1 = Active Privacy. |
| | | Default is 0. |
| 14 | Fechner | Offset B_{O} constant in nits. |
| | Constants | Slope Constant c. These |
| | | constants are used to |
| | | determine the minimum |
| | | viewing luminance as a |
| | | function of the light sensor |
| | | input and reflectance |
| | | factor. |
| | | The offset constant B_{O} |
| | | will range from 1 to 100 |
| | | with a default value of 11. |
| | | Use 1 decimal place. |
| | | The slope constant “c” |
| | | will range from 0.1 to 0.5 |
| | | with a default value of |
| | | 0.273 (3 decimal places. |
| 15 | Table Mod | Selects which table |
| | Selection | modification functions are |
| | | activated. |
| 16 | Table Mod | (not shown in Block |
| | Upload | diagram) Allows |
| | | uploading of tables. |
| 17 | % End Point | This is the percentage of |
| | Overhead | the maximum display |
| | | luminance that is specified |
| | | to use for input gray shade |
| | | levels that are above the |
| | | threshold. The percentage |
| | | should range from 0 to |
| | | 50%. |
| 18 | Table Select | Selects either between the |
| | | Constant Contrast Ratio |
| | | Assignment Table (Table |
| | | Select = 1, default) or the |
| | | Gamma Assignment Table |
| | | (Table Select = 1) |
| 19 | γ_{G} | This is the gamma value |
| | | for the gamma function |
| | | assignment table which is |
| | | normally 2.2. The range |
| | | for this gamma will be |
| | | from 0.5 to 3 with two |
| | | decimal points. The |
| | | default value should be 2.2. |
| 20 | Modifiers | This will be an 8 bit word |
| | | that controls invocation of |
| | | modifier functions. |
| | | Bit 0: M0 = 0 (No |
| | | Modifiers), 1 (Modifiers) |
| | | Bit 1: M1 = 0 (No Mod), 1 |
| | | (End Modifier) |
| | | Bit 2: M2 = 0 (No Mod), 1 |
| | | (IPM Modifier) |
| | | Bit 3: M3 = 0 (No Mod), 1 |
| | | (Gamma Modifier) |
| | | Bits 4-7: M4 = 0 (No Mod), |
| | | 1 (Reserved) |
| 21 | M1 Inputs | End Point Modifier |
| | | Function: |
| | | “% End Point Overhead” |
| | | input is used to allocate |
| | | how much luminance is |
| | | allocated for the input gray |
| | | shades that are greater |
| | | than the threshold. |
| 22 | M2 Inputs | Inflection Point Modifier |
| | | (IPM) Function: |
| | | A1 = Gain of 1^{st} phase |
| | | which can range from −0.5 |
| | | to +0.5 with a default |
| | | value of 0. |
| | | A2 = Gain of 2^{nd} phase |
| | | which can range from −0.5 |
| | | to +0.5 with a default |
| | | value of 0. |
| | | N_{I} = Input gray shade |
| | | inflection number. |
| 23 | M3 Inputs | Gamma Modifier |
| | | Function: |
| | | γ_{M} = −0.9 to 3 with a |
| | | default value of 0.5. |

### Architecture:

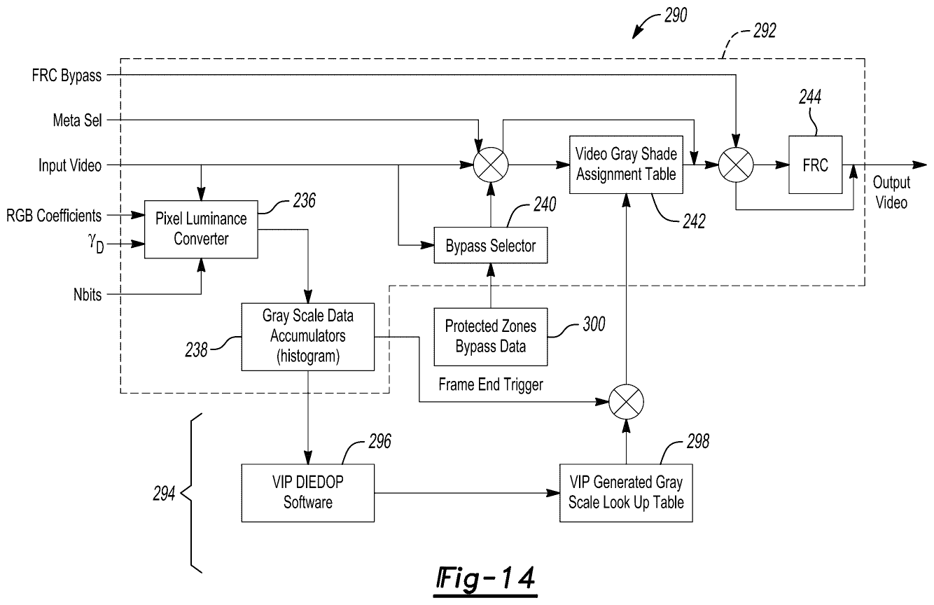

FIG. 14 illustrates an example functional block diagram 290 of an image enhancement architecture in accordance with one or more exemplary embodiments. The architecture generally implements an image enhancement solution (or technique) without a graphics processor and associated full frame memories. In addition, the architecture may minimize latency and provide a cost effective solution. As shown in the figure, an FPGA (or ASIC) 292 creates the histogram on a frame by frame basis (e.g., blocks 236 and 238). The histogram data is sent to the VIP (Vehicle Interface Processor) 294 and the VIP software 296 develops the gray shade look up table 298 based on the histogram and a variety of other inputs. The table is sent back to the FPGA 292 for in-line video processing. The VIP 294 includes a protected zones bypass data block 300 that feeds the bypass selector block 240. The FPGA 292 uses the look up table to convert gray scale levels (e.g., block 242). In addition, the FPGA 292 performs a FRC function (e.g., block 244) to mimic a 10-bit to 11-bit gray shade resolution. Commercial display products generally have a VIP to handle such things as luminance control, touch interface and temperature derating functions. Generally, the VIP 294 has additional bandwidth to handle and process the image enhancement technique and therefore does not add to the incremental cost of providing an image enhancement solution.

### AIE Start Point Enhancement:

The start point enhancement function is operational to smooth the initial shades from the black level instead of immediately having gray shade 1 jump to the LVE level. The technique creates a “Start Function”. The start function may stitch into the main blue “GSN” function created in block 262 of FIG. 13.

An aspect of the Start Point Function is the use of the L_{BG} value to determine an intersection where the Start Point Function connects to the AIE-LVE function. Since L_{BG} is related to the reflected ambient, the use of L_{BG} automatically adjust the intersection between the two functions automatically. As an example, if L_{BG} is lowered from 100 nits to 10 nits, the Start function changes such that the Start Point function uses less of the starting gray shades to accomplish the smoothing function. Note that the end of the Start Point Function is reduced from input gray shade 56 to gray shade 32 in the example.

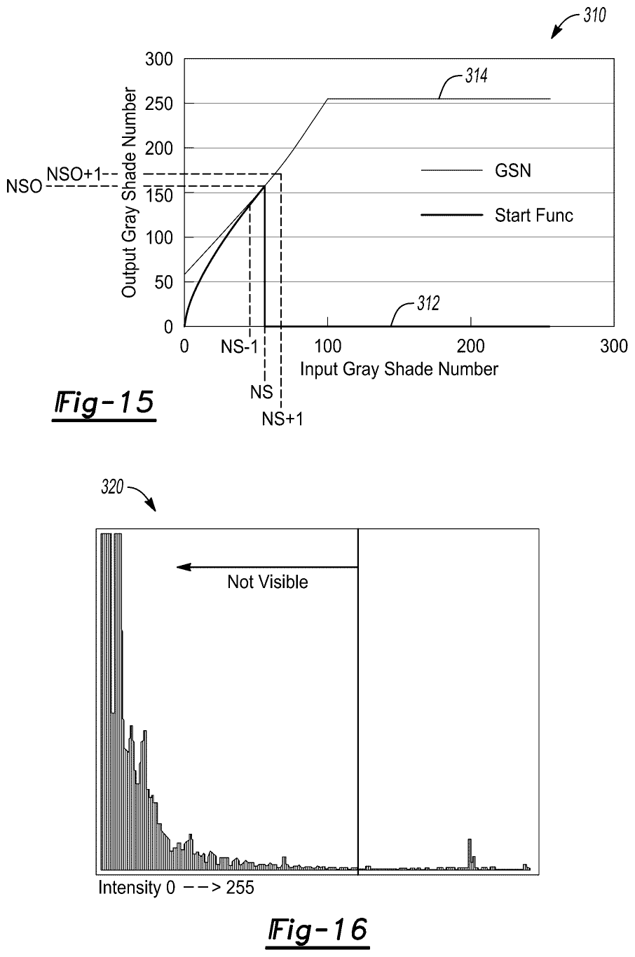

FIG. 15 illustrates a graph 310 for an example start point function definition in accordance with one or more exemplary embodiments. To determine the Start Point Function 312, the following definitions are used as shown in the figure.

N_{S}=Intersection gray shade number between the Start Point Function and the AIE-LVE GS_{N} function. N_{S} is also the end input gray shade for the Start Point Function.

N_{S+1}=Is the next integer gray shade number above input gray shade N_{S}. This is found by adding 1 to N_{S}.

N_{S-1}=Is the next integer gray shade number below input gray shade N_{S}. This is found by subtracting 1 from N_{S}.

N_{S0}=The floating point output gray shade associated with input gray shade number N_{S} for the transfer function used in block 262 of FIG. 13.

N_{S0+1}=The floating point output gray shade associated with input gray shade N_{S+1} for the transfer function used in block 262 of FIG. 13.

Note that an objectives of the start point function is to match the slope of the transfer function used in block 262 at the intersection point defined by input gray shade number N_{S}.

In order to accomplish the objective of slope matching at the intersection point, a method may be to start by using a Start Point gamma function as shown in Equation 116 as follows:

$${F}_{γ SP} = {{N}_{SO} [ \frac{N}{{N}_{S}} ]}^{{γ}_{S}} \qquad Eq . ( 116 )$$

Where γ_{S} is a gamma slope.

The slope of the gamma function just before the intersection point is defined by Equation 117 as follows:

$${S}_{γ SP} = \frac{{{N}_{SO} [ \frac{{N}_{S}}{{N}_{S}} ]}^{{γ}_{S}} - {{N}_{SO} [ \frac{{N}_{S - 1}}{{N}_{S}} ]}^{{γ}_{S}}}{{N}_{S} - {N}_{S - 1}} \qquad Eq . ( 117 )$$

Equation 117 simplifies to Equation 118, as follows, because the denominator is equal to 1 and the N_{S}/N_{S} term also reduces to unity.

$${S}_{γ SP} = {N}_{SO} - {{N}_{SO} [ \frac{{N}_{S - 1}}{{N}_{S}} ]}^{{γ}_{S}} \qquad Eq . ( 118 )$$

The idea is to match the slope of the gamma Start Point Function to the AIE-LVE GS_{N} transfer function curve 314. The slope of the AIE-LVE transfer function curve 314 at the intersection point may be defined per Equation 119 as follows:

$${S}_{S} = \frac{{N}_{SO + 1} - {N}_{SO}}{{N}_{S + 1} - {N}_{S}} \qquad Eq . ( 119 )$$

Equation 119 simplifies to Equation 120, as follows, since the denominator is equal to unity:

$${S}_{S} = {N}_{SO + 1} - {N}_{S O} \qquad Eq . ( 120 )$$

Equation 118 and Equation 120 may be combined by setting the slopes equal to each other per Equation 121 as follows:

$${N}_{SO} - {{N}_{SO} [ \frac{{N}_{S - 1}}{{N}_{S}} ]}^{{γ}_{S}} = {N}_{SO + 1} - {N}_{SO} \qquad Eq . ( 121 )$$

Solving for the gamma slope γ_{S} yields Equation 122 as follows:

$${N}_{SO} - {N}_{SO + 1} + {N}_{SO} = {{N}_{SO} [ \frac{{N}_{S - 1}}{{N}_{S}} ]}^{{γ}_{S}} \qquad Eq . ( 122 )$$

Manipulating Equation 122 yields Equation 123 as follows:

$${[ \frac{{N}_{S - 1}}{{N}_{S}} ]}^{{γ}_{S}} = \frac{{N}_{SO} - {N}_{SO + 1} + {N}_{SO}}{{N}_{SO}} \qquad Eq . ( 123 )$$

Taking the logarithm of both sides results in Equation 124 as follows:

$${γ}_{S} log [ \frac{{N}_{S - 1}}{{N}_{S}} ] = log [ \frac{2 {N}_{SO} - {N}_{SO + 1}}{{N}_{SO}} ] \qquad Eq . ( 124 )$$

Finally solving for γ_{S} results in Equation 125 as follows:

$${γ}_{S} = \frac{log [ \frac{2 {N}_{SO} - {N}_{SO + 1}}{{N}_{SO}} ]}{log [ \frac{{N}_{S - 1}}{{N}_{S}} ]} \qquad Eq . ( 125 )$$

The gamma value calculated from Equation 125 is then used in conjunction with Equation 116 to develop the Start Point Function 312.

An aspect of the calculations may be that the N_{S} point is developed based on the L_{BG} value that is the same as the output value for GS1. To add some additional control, a gain factor, K, may be applied to the GS1 value. Therefore, Equation 126 may be used to determine the rounded integer end point N_{S} value as follows:

$${N}_{S} = K \frac{G {S}_{O 1}}{G {S}_{OMax}} \times 255 \qquad Eq . ( 126 )$$

Alternatively, N_{S} may be determined by using Equation 127 as follows:

$${N}_{S} = K \frac{{L}_{BG}}{{L}_{Max}} \times 255 \qquad Eq . ( 127 )$$

Note that the GS_{O1} is derived from the background luminance value according to the power function formula. There are two forms of the formula to determine the output gray shades: Constant Contrast Ratio; and Offset Gamma.

The constant contrast ratio formula may be calculate per Equation 128 as follows:

$${GS}_{N} = {( {2}^{{N}_{New}} - 1 ) [ \frac{\frac{{L}_{DMax} + {L}_{BG}}{{[ \frac{{L}_{DMax} + {L}_{BG}}{{{B}_{O} ( {L}_{BG} )}^{C} + {L}_{BG}} ]}^{( \frac{T - N}{T - 1} )}} - {L}_{BG}}{{L}_{DMax}} ]}^{( \frac{1}{γ} )} \qquad Eq . ( 128 )$$

If the input gray shade is set to N=1, Equation 128 becomes Equation 129 as follows:

$$G {S}_{N 1} = {( {2}^{{N}_{New}} ) [ \frac{{{B}_{O} ( {L}_{B G} )}^{C}}{{L}_{DMax}} ]}^{( \frac{1}{γ} )} \qquad Eq . ( 129 )$$

For the offset gamma formula per Equation 130, as follows, if N=0, the result is the same as Equation 129.

$$G {S}_{N} = ( {2}^{{N}_{New}} - 1 ) {{L}_{DMax}^{( - 1 / {γ}_{D} )} [ ( {L}_{DLimit} - {{B}_{O} ( {L}_{B G} )}^{C} ) {( \frac{N}{{N}_{Max}} )}^{{γ}_{G}} + {{B}_{O} ( {L}_{B G} )}^{C} ]}^{( \frac{1}{{γ}_{D}} )} \qquad Eq . ( 130 )$$

Therefore, with either method, the lowest gray shade is determined by Equation 129. From a luminance point of view, the display converts the lowest gray shade per Equation 131, as follows, which is just the luminance suitable according to the Silverstein power Equation 2-1.

$${L}_{N 1} = {{L}_{DMax} ( \frac{G {S}_{N 1}}{( {2}^{{N}_{New}} - 1 )} )}^{γ} = {{B}_{O} ( {L}_{B G} )}^{C} \qquad Eq . ( 131 )$$

### Image Enhancement Start Point Exposé:

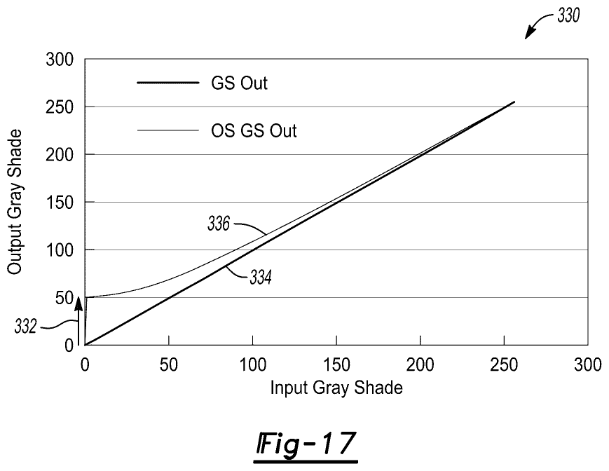

An issue with automotive display imagery is that the lower video gray shade content becomes less visible under reflected ambient lighting conditions. For example, a white poster board (e.g., a white shirt) reflection of 387 nits from the passenger seat washes out the display as seen by the driver for a display with a 1.25% total SCI display reflection rate. Considering the Burnette and Silverstein human factor studies, a 387 nit reflected background luminance results in an approximately 300 nits display luminance to be visible. In various situations, 300 nits equates to about gray shade 150 for a 1000 nit display. Therefore, for a typical cluster display, most of the lower gray shade content may not be visible as shown by the histogram in FIG. 16. Increasing the display luminance does little for lower video content visibility due to the nature of the gamma function that is used in automotive displays.

FIG. 16 illustrates a graph 320 of an example gray shade histogram in accordance with one or more exemplary embodiments. To deal with the lower and intermediate gray shade visibility situations, display luminance criteria continue to increase to levels beyond what is suitable to see the peak white levels. Therefore, image enhancement methods are becoming more attractive to enhance display visibility while reducing power that is becoming more important for electric vehicles.

To have improved visibility of lower and intermediate video content, the lower and intermediate video levels to higher video levels may be dynamically adjusted as a function of ambient lighting conditions, referred to as the adaptive image enhancement. The adaptive image enhancement may be accomplished by measuring the lighting condition and dynamically adjusting the image content for image visibility.

Adaptive Image Enhancement (AIE) offers a method to be able to see lower gray shade content of a display image. Previously, automatic luminance control methods used light sensor information to increase or decrease the luminance level of a display. The previous methods only addressed the visibility of the upper gray shades in a video image. The lower gray shades however remained largely not visible due to the reflected luminance of the display overwhelming and washing out the lower gray shade luminance levels. With the advent of adaptive image enhancement methods, the luminance of the lower gray shades may be increased to the level of visibility with just increasing the overall luminance of the display. However, the control techniques to automatically control both the video path and the display luminance functions may be integrated to provide seamless operation.

The maximum values are controlled by setting the maximum display luminance while the minimum value is set using the gray scale function. As the reflected background luminance changes (x-axis), the minimum gray shade luminance and the maximum gray shade luminance should be automatically changed to the y axis display luminance values. Note that the double arrow red dashed lines indicate the range of the display luminance gray shades. As the reflected background increases, the double red arrow range moves to the right as indicated by the solid green arrow. Therefore, the reflected background luminance (L_{BG}) may be estimated with a light sensor, and the amount of display luminance (ESL) may be calculated to ensure visibility.

Until the advent of adaptive image enhancement, only the top maximum visibility curve may be realized by adjusting the backlight. However, by adjusting the video gray shades using adaptive image enhancement, the bottom minimum visibility curve may now be realized resulting in visibility of the lower gray shades that normally are “washed out” by the attending reflected background luminance.

FIG. 17 illustrates a graph 330 on an example offset gray shade remapping in accordance with one or more exemplary embodiments. To address the lower gray shade visibility problem under a reflected ambient lighting condition, the starting gray shade may be raised 332 to the level of visibility as shown in the FIG. 17. In the figure, the “GS Out” curve 334 is the normal mapping in a display. The “OS GS Out” curve 336 is the remapped gray shades for the offset gamma function.

### Minimum Gray Shade Analysis:

A features of the image enhancement implementation is that the minimum gray shades that the user sees remains constant and is independent of the display maximum luminance. Therefore, the backlight luminance may be decreased to the level suitable for relevant symbology luminance levels, and the minimum gray shade luminance may remain constant. This concept may be explained by first understanding the overall approach of the Adaptive Image Enhancement System.

Between the start point and the end point, the gray shades are determined based on the selected function. Equation 130, above, expresses the mathematical relationship that automatically recalculates the lower gray shade levels as a function of the display luminance.

To analyze Equation 130, above, with respect to lower gray shade independence, the first step is to simplify Equation 130 by rearranging terms as shown in Equation 132 as follows:

$$G {S}_{N} = {( {2}^{{N}_{New}} - 1 ) [ \frac{( {L}_{Max} - {L}_{Min} ) {( \frac{N}{{N}_{Max}} )}^{{γ}_{G}} + {{B}_{O} ( {L}_{B G} )}^{C}}{{L}_{DMax}} ]}^{( \frac{1}{{γ}_{D}} )} \qquad Eq . ( 132 )$$

Substituting the equations for L_{Max} and L_{Min} into Equation 132 yields Equation 133, as follows, which may be utilized to determine the gray shade transfer function between the start point (GS=1) and the end point.

$$G {S}_{N} = ( {2}^{{N}_{N e w}} - 1 ) {[ \frac{( {L}_{DMax} - {{B}_{O} ( {L}_{B G} )}^{C} ) {( \frac{N}{{N}_{Max}} )}^{{γ}_{G}} + {{B}_{O} ( {L}_{B G} )}^{C}}{{L}_{D Max}} ]}^{( \frac{1}{{γ}_{D}} )} \qquad Eq . ( 133 )$$

For the purposed of illustration, the values used in the example are:
c=0.799;
L_{BG}=380 nits (this is the reflected background luminance for 10K Lux illuminance on the display);

$${B}_{O} = 0.2 \; 63 ; and$$

$${γ}_{G} = {γ}_{D} = 2.2 .$$

From these assumptions, the amount of display luminance suitable for minimum visibility may be determined according to Equation 134 as follows:

$${{B}_{O} ( {L}_{B G} )}^{C} = 0.263 {( 380 )}^{0.799} = 30.28 nits \qquad Eq . ( 134 )$$

If a minimum value of N_{Max}=87 is used, the first term in the numerator for a display luminance of 1000 nits and 500 nits may be determined according to Equations 135 and 136, as follows, for the lowest input gray shade of N=1.

$$( 1000 - 30.28 ) {( \frac{1}{87} )}^{2.2} = 0.0 \; 52 nits \qquad Eq . ( 135 )$$

$$( 500 - 30.28 ) {( \frac{1}{87} )}^{2.2} = 0.0 \; 25 nits \qquad Eq . ( 136 )$$

The results observed in Equations 135 and 136 are smaller than the second term (30.28 nits) in the numerator of Equation 133 and may therefore be ignored for N=1. Therefore, for N=1, Equation 137 is realized as follows:

$$G {S}_{N} = {( {2}^{{N}_{N e w}} ) [ \frac{{{B}_{O} ( {L}_{B G} )}^{C}}{{L}_{DMax}} ]}^{( \frac{1}{{γ}_{D}} )} \qquad Eq . ( 137 )$$

Conversion to actual luminance for input gray shade N=1 is accomplished per Equation 138 as follows:

$$L = {{L}_{DMax} ( \frac{G {S}_{N}}{{2}^{{N}_{New}} - 1} )}^{{γ}_{D}} \qquad Eq . ( 138 )$$

Substituting Equation 137 into Equation 138, yields Equation 139 as follows:

$$L = {{L}_{DMax} ( \frac{{( {2}^{{N}_{New}} - 1 ) [ \frac{{{B}_{O} ( {L}_{B G} )}^{C}}{{L}_{DMax}} ]}^{( \frac{1}{{γ}_{D}} )}}{{2}^{{N}_{New}} - 1} )}^{{γ}_{D}} \qquad Eq . ( 139 )$$

Cancelling terms and simplifying Equation 139 results in Equation 140, as follows, which shows that the correct lower luminance level is maintained independent of the display luminance L_{DMax}.

$$L = {{B}_{O} ( {L}_{B G} )}^{C} \qquad Eq . ( 140 )$$

The image enhancement system generally maintains the correct luminance level for the lower shades independent of the display backlight luminance. Therefore. the automatic luminance control system may change the upper gray shades luminance levels without affecting the lowest image enhanced gray shade luminance levels. This characteristic is due to the two-point method used to develop the image enhancement technique where the lower levels and upper luminance levels are independently determined and controlled rather than using a simplistic image enhancement method where only the overall gamma function is controlled.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. An image enhancement system comprising:
an ambient light sensor operational to measure an ambient light level;
a circuit operational to:
generate a histogram based on an input video signal;
export the histogram;
receive a gray shade look up table; and
generate an output video signal by converting a plurality of gray shades in the input video signal based on the gray shade look up table; and
a processor operational to:
receive the histogram from the circuit;
develop the gray shade look up table based on the histogram and the ambient light level; and
transfer the gray shade look up table to the circuit.

2. The image enhancement system according to claim 1, wherein the development of the gray shade look up table involves three functions that are independent of each other, the three functions provide:
a start point function that improves visibility of a plurality of low gray shades based on ambient lighting conditions;
an intermediate function that ensures image gray shade visibility by stretching a plurality of intermediate gray shades; and
an end point function that differentiates a plurality of image white shades based on white shade image content.

3. The image enhancement system according to claim 2, wherein the development of the gray shade look up table includes:
calculate a starting output gray shade;
calculate an associated start point slope; and
change the start point function based on the starting output gray shade and the associated start point slope to seamlessly stitch the start point function to the intermediate function.

4. The image enhancement system according to claim 3, wherein the development of the gray shade look up table includes:
calculate the starting output gray shade with a Fechner function and a light sensor value to maintain low gray shade visibility.

5. The image enhancement system according to claim 4, wherein the development of the gray shade look up table includes:
filter the light sensor value to mimic eye adaptation times.

6. The image enhancement system according to claim 2, wherein the intermediate function includes either a constant contrast ratio between gray shades or an offset gamma function.

7. The image enhancement system according to claim 2, wherein the development of the gray shade look up table includes:
calculate an end point based on a gray shade percentage of the histogram.

8. The image enhancement system according to claim 7, wherein the development of the gray shade look up table includes:
match a gamma slope with a gamma function at the end point.

9. The image enhancement system according to claim 1, wherein the generation of the output video signal includes:
convert a 10-bit video signal or an 11-bit video signal to an 8-bit output video signal with a frame rate control function.

10. The image enhancement system according to claim 1, further comprising:
a display panel operational to generate a visible image based on the video output signal.

11. A method for image enhancement comprising:
measuring an ambient light level with an ambient light sensor;
generating a histogram with a circuit based on an input video signal;
exporting the histogram from the circuit to a processor;
receive the histogram at the processor from the circuit;
developing a gray shade look up table with the processor based on the histogram and the ambient light level;
transferring the gray shade look up table from the processor to the circuit;
receiving the gray shade look up table at the circuit from the processor;
generating an output video signal with the circuit by converting a plurality of gray shades in the input video signal based on the gray shade look up table; and
generating a visible image based on the video output signal.

12. The method according to claim 11, wherein the developing of the gray shade look up table involves three functions that are independent of each other, and the three functions provide:
improving visibility of a plurality of low gray shades with a start point function based on ambient lighting conditions;
ensuring image gray shade visibility by stretching a plurality of intermediate gray shades with an intermediate function; and
differentiating a plurality of image white shades with an end point function based on white shade image content.

13. The method according to claim 12, wherein the developing of the gray shade look up table includes:
calculating a starting output gray shade;
calculating an associated start point slope; and
changing the start point function based on the calculated starting output gray shade and the associated start point slope to seamlessly stitch the start point function to the intermediate function.

14. The method according to claim 13, wherein the developing of the gray shade look up table includes:
calculating the starting output gray shade using a Fechner function and a light sensor value to maintain low gray shade visibility.

15. The method according to claim 14, wherein the developing of the gray shade look up table includes:
filtering the light sensor value to mimic eye adaptation times.

16. The method according to claim 12, wherein the intermediate function includes either a constant contrast ratio between gray shades or an offset gamma function.

17. The method according to claim 12, wherein the developing of the gray shade look up table includes:
calculating an end point of the end point function based on a gray shade percentage of the histogram.

18. The method according to claim 17, wherein the developing of the gray shade look up table includes:
matching a gamma slope with a gamma function at the end point.

19. The method according to claim 11, wherein the generating of the output video signal includes:
converting a 10-bit video signal or an 11-bit video signal to an 8-bit output video signal with a frame rate control function.

20. A vehicle comprising:
an ambient light sensor operational to measure an ambient light level;
a control unit coupled to the ambient light sensor and operational to:
generate an input video signal;
generate a histogram based on the input video signal;
develop a gray shade look up table based on the histogram and the ambient light level; and
generate an output video signal by converting a plurality of gray shades in the input video signal based on the gray shade look up table; and
a display panel coupled to the control unit and operational to generate a visible image based on the video output signal.
